(19) United States
(12) Patent Application Publication
(10) Pub. No.: US 2024/0340144 A1
(43) Pub. Date: Oct. 10, 2024

(54) REFERENCE SIGNAL SEQUENCE INDICATION IN ORBITAL ANGULAR MOMENTUM (OAM) COMMUNICATION SYSTEMS

(71) Applicant: QUALCOMM Incorporated, San Diego, CA (US)

(72) Inventors: Min Huang, Beijing (CN); Chao Wei, Beijing (CN); Wei Xi, Beijing (CN); Hao Xu, Beijing (CN)

(21) Appl. No.: 18/700,054

(22) PCT Filed: Dec. 16, 2021
(86) PCT No.: PCT/CN2021/138656

§ 371 Date: Apr. 10, 2024

(51) Int. Cl. H04L 5/00; H04B 7/0404; H04B 7/26

(52) U.S. Cl. CPC H04L 5/0051; H04B 7/0404; H04B 7/2612

(57) ABSTRACT

Techniques related to reference signal sequence indication in orbital angular momentum (OAM) communication systems are disclosed. Some aspects of the disclosure relate to apparatuses and methods for wireless communication, an apparatus comprising: a processor; antenna elements; a transceiver coupled to the processor and antenna elements; and a memory coupled to the processor, the processor and the memory configured to: receive a first reference signal on a first OAM mode using first resources; identify, based on the first OAM mode used to receive the first reference signal, a second OAM mode to be used to receive a second reference signal associated with second resources; and receive the second reference signal on the second OAM mode using the second resources. Other aspects, embodiments, and features are also claimed and described.

### TECHNICAL FIELD

The technology discussed below relates generally to wireless communication systems, and more particularly, to transmission and reception of reference signals. For example, some aspects of the disclosed technology can provide and enable techniques for indicating sequencing of reference mode transmissions in orbital angular momentum (OAM) systems.

### INTRODUCTION

In wireless communication, information is transmitted over electromagnetic radiation by modulating a carrier signal with one or more information signals. Many techniques for modulating a carrier signal are used in the art, including various analog and digital modulation techniques such as frequency modulation (FM), amplitude modulation (AM), phase-shift keying (PSK), and quadrature amplitude modulation (QAM), among numerous others. In a typical cellular wireless communication system, many such signals can be multiplexed (e.g., combined) onto a suitable carrier or band to enable simultaneous communication between multiple devices. Once again, many techniques for multiplexing and multiple access are used in the art, including frequency-division multiplexing (FDM), time-division multiplexing (TDM), and orthogonal frequency-division multiplexing (OFDM), among many others.

As the demand for mobile broadband access continues to increase, research and development continue to advance wireless communication technologies not only to meet the growing demand for mobile broadband access, but to advance and enhance the user experience with mobile communications.

### BRIEF SUMMARY OF SOME EXAMPLES

The following presents a simplified summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one example, an apparatus configured for wireless communication is disclosed. In a more particular example, the apparatus includes: a processor; a plurality of antenna elements; a transceiver coupled to the processor and to plurality of antenna elements; and a memory coupled to the processor, wherein the processor and the memory are configured to: receive, via the transceiver and a first antenna element of the plurality of antenna elements, a first reference signal on a first orbital angular momentum (OAM) mode using first resources; identify, based on the first OAM mode used to receive the first reference signal, a second OAM mode to be used to receive a second reference signal associated with second resources; and receive, via the transceiver and the first antenna element of the plurality of antenna elements, the second reference signal on the second OAM mode using the second resources.

In another example, another apparatus configured for wireless communication is disclosed. In a more particular example, the apparatus includes: a processor; a plurality of antenna elements; a transceiver coupled to the processor and to plurality of antenna elements; and a memory coupled to the processor, wherein the processor and the memory are configured to: transmit, via the transceiver, information indicative of a sequence of orbital angular momentum (OAM) modes to be used to transmit synchronization signals, including a first OAM mode and a second OAM mode; transmit, via the transceiver and a first antenna element of the plurality of antenna elements, a first reference signal on the first OAM mode using first resources in accordance with the sequence; transmit, via the transceiver and the first antenna element of the plurality of antenna elements, a second reference signal on the second OAM mode using second resources in accordance with the sequence.

In yet another example, a method for wireless communication is disclosed. In a more particular example, the method includes: receiving, via a transceiver and a first antenna element of a plurality of antenna elements, a first reference signal on a first orbital angular momentum (OAM) mode using first resources; identifying, based on the first OAM mode used to receive the first reference signal, a second OAM mode to be used to receive a second reference signal associated with second resources; and receiving, via the transceiver and the first antenna element of the plurality of antenna elements, the second reference signal on the second OAM mode using the second resources.

In still another example, another method for wireless communication is disclosed. In a more particular example, the method includes: transmitting, via a transceiver, information indicative of a sequence of orbital angular momentum (OAM) modes to be used to transmit synchronization signals, including a first OAM mode and a second OAM mode; transmitting, via a transceiver and a first antenna element of a plurality of antenna elements, a first reference signal on the first OAM mode using first resources in accordance with the sequence; transmitting, via the transceiver and the first antenna element of the plurality of antenna elements, a second reference signal on the second OAM mode using second resources in accordance with the sequence.

### BRIEF DESCRIPTION OF THE DRAWINGS

FIG. 1 is a schematic illustration of a radio access network according to some aspects of this disclosure.

FIG. 2 is a schematic illustration of wireless communication between multi-antenna devices according to some aspects of this disclosure.

FIG. 3 is a block diagram conceptually illustrating an example of a hardware implementation for a transmitting device according to some aspects of the disclosure.

FIG. 4 is a block diagram conceptually illustrating an example of a hardware implementation for a receiving device according to some aspects of the disclosure.

FIG. 5 is a schematic illustration of wireless communication via a spiral phase plate (SPP) configuration that supports the use of orbital angular momentum (OAM) modes for multiplexing communications in accordance with some aspects of this disclosure.

FIG. 6 is a schematic illustration of wireless communication via a uniform circular array (UCA) configuration that supports the use of orbital angular momentum (OAM) modes for multiplexing communications in accordance with some aspects of this disclosure.

FIG. 7 is a schematic illustration of a coaxial multi-circle OAM configuration that supports two-dimensional index modulation according to some aspects of this disclosure.

FIG. 8 is a call flow diagram illustrating an exemplary process for transmitting and receiving synchronization signal blocks (SSBs) using a reference signal sequence indication in accordance with some aspects of this disclosure.

### DETAILED DESCRIPTION

In some aspects, this disclosure provides for a wireless communication technique that exploits an orbital angular momentum (OAM) property of electromagnetic (EM) waves for modulating a carrier to carry information, and/or for multiplexing information streams onto a common wireless resource. In particular, a coaxial multi-circle uniform circular array (UCA)-based antenna may be utilized to transmit reference signals for multiple OAM modes using a predetermined sequence of resources, such that a receiving device may determine resources that are to be used to transmit subsequent reference signals based on the detection of a reference signal for a particular mode. Other aspects, embodiments, and features are also described and claimed.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes aspects and embodiments by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

In communication systems, modulation is a technique for systematically varying a carrier signal in such a way that the transmitted signal contains information. Many techniques for modulating a carrier signal are used in the art, including various analog and digital modulation techniques. Modern wireless communication devices often employ quadrature amplitude modulation (QAM), where a pair of quadrature (orthogonal) carrier signals have their amplitudes controlled to represent a desired location in a complex plane (sometimes referred to as a Gauss plane).

Relatedly, multiplexing and multiple access are techniques for enabling simultaneous communication of multiple signals and/or devices on the same channel. For example, 5G New Radio (NR) specifications provide multiple access for uplink transmissions from mobile devices to base stations, and for multiplexing for downlink transmissions from base stations to mobile devices, utilizing orthogonal frequency division multiplexing (OFDM) with a cyclic prefix (CP). In addition, for uplink transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes. For example, a mobile device may provide for uplink multiple access utilizing time division multiple access (TDMA), code division multiple access (CDMA), frequency division multiple access (FDMA), sparse code multiple access (SCMA), resource spread multiple access (RSMA), orbital angular momentum (OAM) multiple access, coaxial multi-circle antenna multiple access, and/or other suitable multiple access schemes. Further, a base station may multiplex DL transmissions to UEs utilizing time division multiplexing (TDM), code division multiplexing (CDM), frequency division multiplexing (FDM), orthogonal frequency division multiplexing (OFDM), sparse code multiplexing (SCM), orbital angular momentum (OAM) multiplexing, coaxial multi-circle antenna multiplexing, and/or other suitable multiplexing schemes.

### OAM

An EM transmission can be characterized as a wave that carries momentum. In some examples, this momentum can include angular momentum, which includes a spin angular momentum (SAM) component, and an orbital angular momentum (OAM) component. In some cases, the SAM of the EM wave may be associated with the polarization of the EM wave. For example, an EM wave may be associated with different polarizations, such as left, right, and circular polarizations. Accordingly, the SAM of an EM wave may have multiple (e.g., two) degrees of freedom.

In some cases, the OAM of the EM wave may be associated with a field spatial distribution of the EM wave, which may be in the form of a helical or twisted wavefront shape. For example, an EM wave or light beam may be in a helical mode, which may also be referred to as an OAM mode; and such helical mode may be characterized by a wavefront that is shaped as a helix with an optical vortex in the center (e.g., at the beam axis), where each helical mode is associated with a different helical wavefront structure. The helical modes (e.g., OAM modes) may be defined or referred to by a mode index l, where a sign of the mode index l corresponds to a ‘handedness’ (e.g., left or right) of the helix or helices; and a magnitude of the mode index l (e.g., |l|) corresponds to a quantity of distinct but interleaved helices of the EM wave.

For example, for an EM wave associated with an OAM mode index of l=0, the EM wave is not helical, and the wavefronts of the EM wave are multiple disconnected surfaces (e.g., the EM wave is a sequence of parallel planes). For an EM wave associated with an OAM mode index of l=+1, the EM wave may propagate in a right-handed sense (e.g., the EM wave may form a right helix that rotates about the beam axis in a clockwise direction) and the wavefront of the EM wave may be shaped as a single helical surface with a step length equal to a wavelength of the EM wave. Likewise, the phase delay over one revolution of the EM wave may be equal to 2π. Similarly, for an OAM mode index of l=−1, the EM wave may propagate in a left-handed sense (e.g., the EM wave may form a left helix that rotates about the beam axis in a counter-clockwise direction) and the wavefront of the EM wave may be also be shaped as a single helical surface with a step length equal to the wavelength λ of the EM wave. Likewise, the phase delay over one revolution of the EM wave may be equal to −2π.

In a further example, for an OAM mode index of l=±2, the EM wave may propagate in either a right-handed sense (if l=+2) or in a left-handed sense (if l=−2) and the wavefront of the EM wave may include two distinct but interleaved helical surfaces. In such examples, the step length of each helical surface may be equal to λ/2. Likewise, the phase delay over one revolution of the EM wave may be equal to ±4π. In general terms, a mode-l EM wave may propagate in either a right-handed sense or a left-handed sense (depending on the sign of l) and may include l distinct but interleaved helical surfaces with a step length of each helical surface equal to π/|l|. Likewise, the phase delay over one revolution of the EM wave may be equal to 2lπ. In some cases, an EM wave may be indefinitely extended to provide for a theoretically infinite number of degrees of freedom of the OAM of the EM wave (e.g., l∈ [symbol] , where [symbol] is the unbounded set of integers). As such, the OAM of the EM wave may be associated with an infinite number of degrees of freedom.

### OAM Modulation

In some examples, the OAM mode index l of an EM wave may correspond to or otherwise function as (e.g., be defined as) an additional dimension for signal or channel multiplexing. For example, each OAM mode or state (of which there may be an infinite number) may function similarly (or equivalently) to a communication channel, such as a sub-channel. In other words, an OAM mode or state may correspond to a communication channel, and vice-versa. For instance, a transmitting device or a receiving device may communicate separate signals using EM waves having different OAM modes or states similar to how a transmitting device or receiving device may communicate separate signals over different communication channels. In some aspects, such use of the OAM modes or states of an EM wave to carry different signals may be referred to as the use of OAM beams.

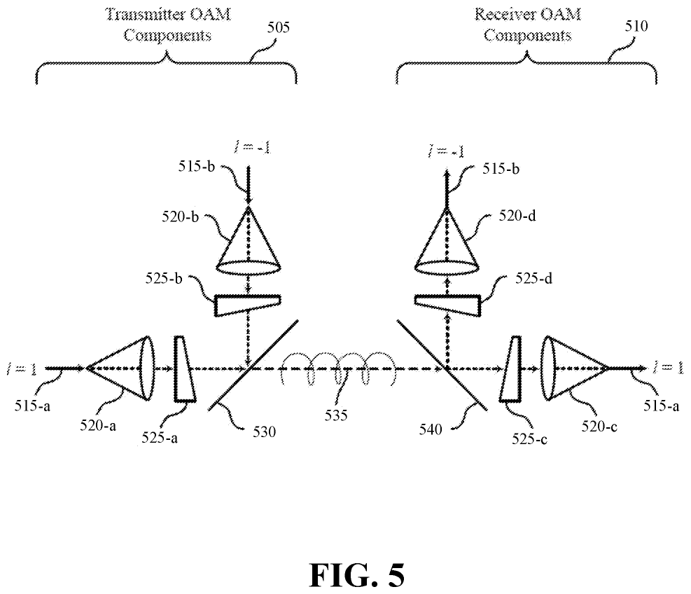

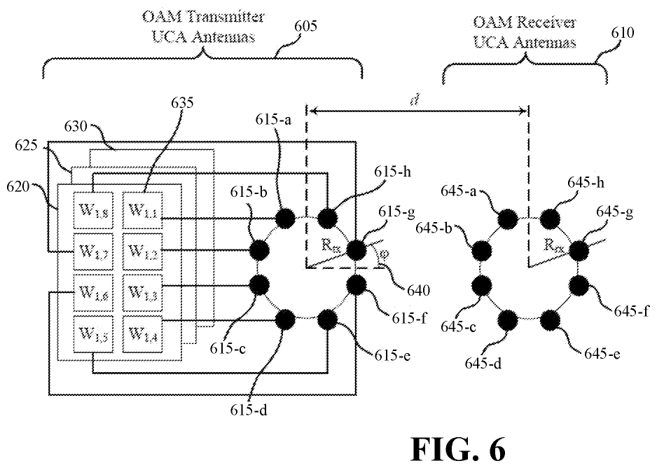

Additionally, in some examples, EM waves with different OAM modes (e.g., OAM states) may be mutually orthogonal to each other (e.g., in a Hilbert sense, in which a space may include an infinite set of axes and sequences may become infinite by way of always having another coordinate direction in which next elements of the sequence can go). Likewise, in a Hilbert sense, orthogonal OAM modes or states may correspond to orthogonal communication channels (e.g., orthogonal sequences transmitted over a communication channel) and, based on the potentially infinite number of OAM modes or states, a wireless communication system employing the use of OAM beams may theoretically achieve infinite capacity. Here, due to the mutual orthogonality among OAM modes, the waveform of one OAM mode generally cannot be received by a receiver aperture configured for a different OAM mode. In theory, an infinite number of OAM states or modes may be twisted together for multiplexing, and the capacity of the OAM link can approach infinity while preserving orthogonality between signals carried by different OAM modes (e.g., indices l). In practice, however, due to non-ideal factors (e.g., Tx/Rx axial and/or position placement error, propagation divergence, and the like), there may be crosstalk among OAM modes at the receiver, and thus a reduced number of concurrent OAM modes may be implemented between wireless devices. In some cases, a transmitting device may generate such OAM beams using spiral phase plate (SPP) or uniform circular array (UCA) configurations, such as discussed with reference to FIGS. 5 and 6.

### Wireless Communication System

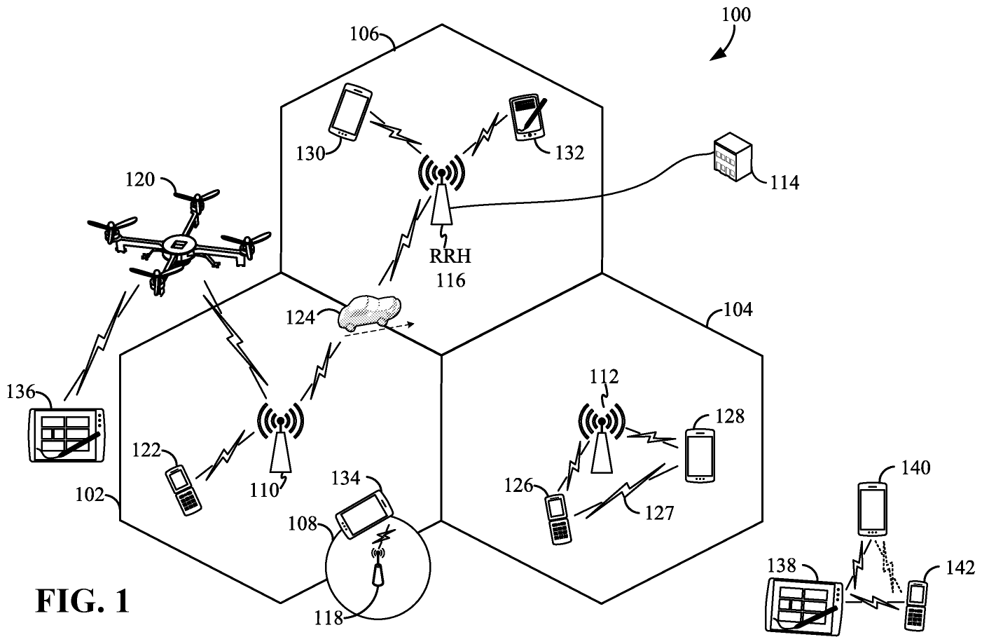

The disclosure that follows presents various concepts that may be implemented across a broad variety of telecommunication systems, network architectures, and communication standards. FIG. 1 illustrates an example of a radio access network (RAN) 100 operating in a wireless communication system that supports one- and/or two-dimensional index modulation in connection with coaxial multi-circle OAM transmissions. By virtue of the wireless communication system 100, the UE 106 may be enabled to carry out data communication with an external data network 110, such as (but not limited to) the Internet.

The RAN 100 may implement any suitable wireless communication technology or technologies to provide radio access to one or more UEs. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, the RAN 100 may operate according to any suitable 6G or other technology, and many other examples may be utilized within the scope of the present disclosure.

In FIG. 1, two base stations 110 and 112 are shown in cells 102 and 104; and a third base station 114 is shown controlling a remote radio head (RRH) 116 in cell 106. That is, a base station can have an integrated antenna or can be connected to an antenna or RRH by feeder cables. Broadly, a base station is a network element in a RAN responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The geographic area covered by the RAN 100 may be divided into cellular regions (cells) that can be uniquely identified by a user equipment (UE) based on an identification broadcasted from one access point or base station. FIG. 1 illustrates macrocells 102, 104, and 106, and a small cell 108, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In the illustrated example, the cells 102, 104, and 126 may be referred to as macrocells, as the base stations 110, 112, and 114 support cells having a large size. Further, a base station 118 is shown in the small cell 108 (e.g., a microcell, picocell, femtocell, home base station, home Node B, home eNode B, etc.) which may overlap with one or more macrocells. In this example, the cell 108 may be referred to as a small cell, as the base station 118 supports a cell having a relatively small size. Cell sizing can be done according to system design as well as component constraints.

It is to be understood that the RAN 100 may include any number of wireless base stations and cells. Further, a relay node may be deployed to extend the size or coverage area of a given cell. The base stations 110, 112, 114, 118 provide wireless access points to a core network for any number of mobile apparatuses.

The RAN 100 supports wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides access to network services. A UE may take on many forms and can include a range of devices.

Within the present document, a “mobile” apparatus (e.g., a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 100 and a UE may be described as utilizing an air interface. The UEs and the base stations may wirelessly communicate with one another via one or more communication links utilizing one or more carriers. The term “carrier” may refer to a set of radio frequency spectrum resources having a defined physical layer structure for supporting the communication links. Transmissions over the air interface from a base station to one or more UEs may be referred to as downlink (DL) transmission. In accordance with certain aspects of the present disclosure, the term downlink may refer to a point-to-multipoint transmission originating at a scheduling entity (e.g., a base station). Another way to describe this scheme may be to use the term broadcast channel multiplexing. Transmissions from a UE to a base station may be referred to as uplink (UL) transmissions. In accordance with further aspects of the present disclosure, the term uplink may refer to a point-to-point transmission originating at a scheduled entity (e.g., a UE).

In general, base stations may include a backhaul interface (not illustrated) for communication with a backhaul portion of the wireless communication system. The backhaul may provide a link between a base station and a core network. Further, in some examples, a backhaul network may provide interconnection between the respective base stations. Various types of backhaul interfaces may be employed, such as a direct physical connection, a virtual network, or the like using any suitable transport network. In some aspects, a portion of a backhaul network may be implemented using OAM transmitters and receivers, each associated with a respective base station and/or portion of the core network.

In some examples, one or more base stations in the RAN 100 may be configured as integrated access and backhaul (IAB) nodes, where the wireless spectrum may be used both for access links (e.g., wireless links with UEs), and for backhaul links. This scheme is sometimes referred to as wireless self-backhauling. By using wireless self-backhauling, rather than requiring each new base station deployment to be outfitted with its own hard-wired backhaul connection, the wireless spectrum utilized for communication between the base station and UE may be leveraged for backhaul communication, enabling fast and easy deployment of highly dense small cell networks. Additionally or alternatively, OAM transmissions may be leveraged for backhaul communication, which may reduce an impact of wireless backhaul communications on wireless spectrum utilized for communication between the base station and UE when communications with UEs utilizes a different technology.

FIG. 1 further includes a quadcopter or drone 120, which may be configured to function as a base station. That is, in some examples, a cell may not necessarily be stationary, and the geographic area of the cell may move according to the location of a mobile base station such as the quadcopter 120.

Each base station 110, 112, 114, 118, and 120 may be configured to provide an access point to a core network for all the UEs in the respective cells. For example, UEs 122 and 124 may be in communication with base station 110; UEs 126 and 128 may be in communication with base station 112; UEs 130 and 132 may be in communication with base station 114 by way of RRH 116; UE 134 may be in communication with base station 118; and UE 136 may be in communication with mobile base station 120.

In some examples, a mobile network node (e.g., quadcopter 120) may be configured to function as a UE. For example, the quadcopter 120 may operate within the cell 102 by communicating with the base station 110.

In a further aspect of the RAN 100, sidelink signals may be used between UEs without necessarily relying on scheduling or control information from a base station. For example, two or more UEs (e.g., UEs 126 and 128) may communicate with each other using peer to peer (P2P) or sidelink signals 127 without relaying that communication through a base station (e.g., base station 112). In a further example, UE 138 is illustrated communicating with UEs 140 and 142. Here, the UE 138 may function as a scheduling entity or a primary sidelink device, and UEs 140 and 142 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 140 and 142 may optionally communicate directly with one another in addition to communicating with the scheduling entity 138. Thus, in a wireless communication system with scheduled access to time-frequency resources and having a cellular configuration, a P2P configuration, or a mesh configuration, a scheduling entity and one or more scheduled entities may communicate utilizing the scheduled resources.

In some examples, The RAN 100 may operate in a super high frequency (SHF) region (e.g., using frequency bands from 3 GHz to 30 GHz), also known as the centimeter band, in an extremely high frequency (EHF) region of the spectrum (e.g., using frequency bands from 30 GHz to 300 GHz), also known as the millimeter band, or in even higher frequency bands reaching into the terahertz (THz) range. And in some examples, the RAN 100 may support millimeter wave (mmW) communications between the UEs and the base stations, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

### Multi-Antenna Arrays Generally

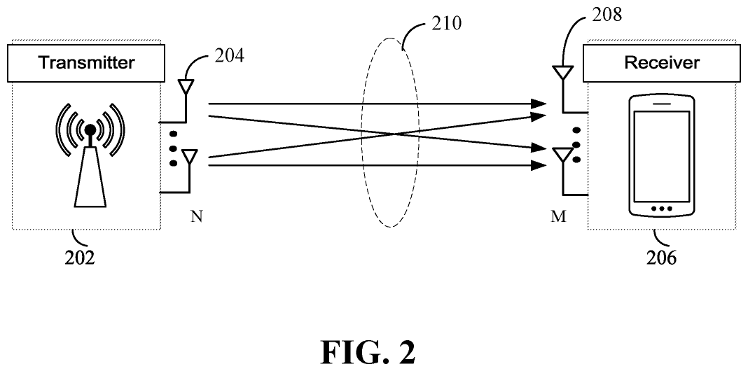

In some aspects of the disclosure, a wireless communication node or device may be configured with multiple antennas, e.g., for beamforming, multiple-input multiple-output (MIMO), and/or orbital angular momentum (OAM) modulation technology. FIG. 2 illustrates an example of wireless communication utilizing multiple antennas, supporting beamforming, MIMO, and OAM. In some examples, the system of FIG. 2 may implement aspects of RAN 100. The use of such multiple antenna technology enables a wireless communication system to exploit the spatial domain to support spatial multiplexing, beamforming, and transmit diversity.

Beamforming generally refers to directional signal transmission or reception. For a beamformed transmission, the amplitude and phase of each antenna in an array of antennas may be precoded, or controlled to create a desired (e.g., directional) pattern of constructive and destructive interference in the wavefront. In a MIMO system, a transmitter 202 includes multiple transmit antennas 204 (e.g., N transmit antennas) and a receiver 206 includes multiple receive antennas 208 (e.g., M receive antennas). Thus, there are N×M signal paths 210 from the transmit antennas 204 to the receive antennas 208. Each of the transmitter 202 and the receiver 206 may be implemented, for example, within a scheduling entity 108, a scheduled entity 106, or any other suitable wireless communication device.

In a MIMO system, spatial multiplexing may be used to transmit multiple different streams of data, also referred to as layers, simultaneously on the same time-frequency resource. In some examples, a transmitter may send multiple data streams to a single receiver. In this way, a MIMO system takes advantage of capacity gains and/or increased data rates associated with using multiple antennas in rich scattering environments where channel variations can be tracked. Here, the receiver may track these channel variations and provide corresponding feedback to the transmitter. In the simplest case, a rank-2 (i.e., including 2 data streams) spatial multiplexing transmission on a 2×2 MIMO antenna configuration will transmit two data streams via two transmit antennas 204. The signal from each transmit antenna 204 reaches each receive antenna 208 along a different signal path 210. The receiver 206 may then reconstruct the data streams using the received signals from each receive antenna 208.

The number of data streams or layers in a MIMO system corresponds to the rank of the transmission. In general, the rank of a MIMO system is limited by the number of transmit or receive antennas 204 or 208, whichever is lower. In addition, the channel conditions at the receiving device, as well as other considerations, such as the available resources at the transmitting device, may also affect the transmission rank. For example, a base station in a cellular RAN may assign a rank (and therefore, a number of data streams) for a DL transmission to a particular UE based on a rank indicator (RI) the UE transmits to the base station. The UE may determine this RI based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI along with resource information (e.g., the available resources and amount of data to be scheduled for the UE) to assign a DL transmission rank to the UE.

The transmitting device determines the precoding of the transmitted data stream or streams based, e.g., on known channel state information of the channel on which the transmitting device transmits the data stream(s). For example, the transmitting device may transmit one or more suitable reference signals (e.g., a channel state information reference signal, or CSI-RS) that the receiving device may measure. The receiver may then report measured channel quality information (CQI) back to the transmitting device. This CQI generally reports the current communication channel quality, and in some examples, a requested transport block size (TBS) for future transmissions to the receiver. In some examples, the receiver may further report a precoding matrix indicator (PMI) back to the transmitting device. This PMI generally reports the receiving device's preferred precoding matrix for the transmitting device to use, and may be indexed to a predefined codebook. The transmitting device may then utilize this CQI/PMI to determine a suitable precoding matrix for transmissions to the receiver.

In some cases, the RAN 100 may be an example of or otherwise support an OAM-based communication system and a transmitting device 202 and/or a receiving device 206 may communicate via OAM beams. In some examples, the transmitting device 202 and/or the receiving device 206 may generate and steer an OAM beam based on selecting a set of antenna elements from a planar array of antenna elements (e.g., a planar array on the transmitting device 202 or a receiving device 206 that may be used for MIMO communications) based on which antenna elements fall within a determined area on the planar array associated with a uniform circular array (UCA) for OAM communications. Additionally or alternatively, one or more transmitting devices 202 or receiving 206 may include components that provide for spiral phase plate (SPP)-based OAM communications.

In various examples, some or all of the wireless resources of the RAN 100 may be scheduled to carry one or more physical channels, including control channels, shared channels, data channels, etc. Other resources of the RAN 100 may also carry pilots or reference signals. These pilots or reference signals may provide for a receiving device to perform channel estimation of the corresponding channel.

In a DL transmission, the transmitting device (e.g., a base station or scheduling entity) may allocate a set of wireless resources to carry DL control information including one or more DL control channels that generally carry information originating from higher layers to one or more receiving devices (e.g., a UE or scheduled entity). In addition, DL resources may be allocated to carry DL physical signals that generally do not carry information originating from higher layers. These DL physical signals may include synchronization signals, demodulation reference signals (DM-RS), phase-tracking reference signals (PT-RS), channel-state information reference signals (CSI-RS), etc.

In an UL transmission, a transmitting device (e.g., a UE or scheduled entity) may utilize a set of designated wireless resources to carry UL control information (UCI) to a receiving device (e.g., a base station or scheduling entity). The UCI can originate from higher layers via one or more UL control channels. Further, UL wireless resources may carry UL physical signals that generally do not carry information originating from higher layers, such as demodulation reference signals (DM-RS), phase-tracking reference signals (PT-RS), sounding reference signals (SRS), etc.

In a sidelink (SL) transmission, a transmitting device (e.g., a UE or scheduled entity, or a base station of scheduling entity) may utilize a set of designated wireless resources to carry SL control information (SCI) to a receiving device (e.g., another UE or scheduled entity, or another base station of scheduling entity). Further, SL wireless resources may carry SL physical signals that generally do not carry information originating from higher layers, such as demodulation reference signals (DM-RS), phase-tracking reference signals (PT-RS), sounding reference signals (SRS), etc.

In addition to control information, wireless resources may be allocated for user data or traffic data, which may be carried on one or more traffic channels.

### Wireless Resources

Those of ordinary skill in the art will understand that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

In some examples, a frame may refer to a predetermined duration of time (e.g., 10 ms) for wireless transmissions. And further, each frame may consist of a set of subframes (e.g., 10 subframes of 1 ms each). A given carrier may include one set of frames in the UL, and another set of frames in the DL.

A resource grid may represent time-frequency resources for a given antenna port. For example, in a MIMO implementation with multiple antenna ports available, a corresponding multiple number of resource grids may be available for communication. As another example, as described below, different OAM modes may be orthogonal when transmitted using the same time, frequency, and/or code resources, and thus may be associated with independent resource grids.

A resource grid may be divided into multiple resource elements (REs). An RE, which is 1 subcarrier×1 symbol, is the smallest discrete part of the time-frequency grid, and may contain a single complex value representing data from a physical channel or signal. Depending on the modulation utilized in a particular implementation, each RE may represent one or more bits of information. In some examples, a block of REs may be referred to as a physical resource block (PRB) or more simply a resource block (RB), which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. The present disclosure assumes, by way of example, that a single RB entirely corresponds to a single direction of communication (either transmission or reception for a given device).

A UE generally utilizes only a subset of a resource grid. An RB may be the smallest unit of resources that a scheduler can allocate to a UE. Thus, the more RBs scheduled for a UE, and the higher the modulation scheme chosen for the air interface, the higher the data rate for the UE. While a UE may use only a subset of a resource grid (e.g., to permit other UEs to also communicate using the RAN), an OAM transmitter and OAM receiver may utilize a much greater portion of the resource grid associated with one or more OAM modes. For example, there may not be other devices configured to use the same resources as there often are when utilizing mobile resources in a RAN. An OAM transmitter and receiver pair are generally closely spatially aligned, potentially reducing the ability to use the antennas to communicate with other devices that are not closely aligned.

### Description of Channels and Signals

Various REs within an RB may carry one or more physical channels, including control channels, shared channels, data channels, etc. Other REs within the RB may also carry pilots or reference signals. These pilots or reference signals may provide for a receiving device to perform channel estimation of the corresponding channel, which may enable coherent demodulation/detection of the control and/or data channels within the RB.

In a DL transmission, the transmitting device (e.g., a base station or a UE) may allocate one or more REs (e.g., within a control region) to carry one or more DL control channels. These DL control channels include DL control information (DCI) that generally carries information originating from higher layers, such as a physical broadcast channel (PBCH), a physical downlink control channel (PDCCH), etc., to one or more receiving devices (e.g., a UE). In addition, the transmitting device may allocate one or more DL REs to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

A base station (or other suitable transmitter device) may transmit the synchronization signals PSS and SSS (collectively referred to as SS), and in some examples, the PBCH, in a synchronization signal block (SSB) that includes 4 consecutive OFDM symbols, numbered via a time index in increasing order from 0 to 3. In the frequency domain, the SSB may extend over 240 contiguous subcarriers, with the subcarriers being numbered via a frequency index in increasing order from 0 to 239. Of course, the present disclosure is not limited to this specific SSB configuration. Other nonlimiting examples may utilize greater or fewer than two synchronization signals; may include one or more supplemental channels in addition to the PBCH; may omit a PBCH; and/or may utilize nonconsecutive symbols for an SSB, within the scope of the present disclosure.

In some communication networks (e.g., including those defined according to 5G NR), a base station can be expected to broadcast synchronization signal blocks (SSBs) to all UEs in a cell, which can be accomplished by transmitting the SSBs in every beam direction (e.g., using beam sweeping techniques) as one or more UEs may be located in a variety of locations or directions with respect to the base station. In communications using OAM, an OAM transmitter and OAM receiver may be closely aligned, and thus there may not be need to transmit SSBs in different beam directions. In some aspects, an OAM transmitter can transmit SSBs associated with each OAM mode that may be used to communicate with an OAM receiving device. As described above, the OAM mode used to transmit a signal at an OAM transmitter matches a particular OAM mode used to detect the signal at the OAM receiver. In general, an OAM transmitter and OAM receiver can be expected to be directionally aligned (e.g., coaxially).

In some communication networks (e.g., including those defined according to 5G NR), each SSB transmission may be associated with an SSB index, which may correspond to a beam index and/or direction used to transmit the SSB. The SSB index may be used to inform scheduling of multiple UEs, which may increase the number of UEs that can be used in a particular cell. In 5G NR, determining the SSB index of a received SSB may include determining a DM-RS sequence index, and extracting information from a master information block.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a scheduled entity) may utilize one or more REs to carry one or more UL control channels, such as a physical uplink control channel (PUCCH), a physical random access channel (PRACH), etc. These UL control channels include UL control information (UCI) that generally carries information originating from higher layers. Further, UL REs may carry UL physical signals that generally do not carry information originating from higher layers, such as demodulation reference signals (DM-RS), phase-tracking reference signals (PT-RS), sounding reference signals (SRS), etc. In some examples, the control information may include a scheduling request (SR), i.e., a request for the scheduling entity to schedule uplink transmissions. Here, in response to the SR transmitted on the control channel, the scheduling entity may transmit downlink control information that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein a receiving device can check the integrity of packet transmissions for accuracy, e.g., utilizing any suitable integrity checking mechanism, such as a checksum or a cyclic redundancy check (CRC). If the receiving device confirms the integrity of the transmission, it may transmit an ACK, whereas if not confirmed, it may transmit a NACK. In response to a NACK, the transmitting device may send a HARQ retransmission, which may implement chase combining, incremental redundancy, etc.

In addition to control information, one or more REs may be allocated for user data or traffic data. Such traffic may be carried on one or more traffic channels, such as, for a DL transmission, a physical downlink shared channel (PDSCH); or for an UL transmission, a physical uplink shared channel (PUSCH).

The channels or carriers described above are not necessarily all the channels or carriers that may be utilized between a scheduling entity and one or more scheduled entities, and those of ordinary skill in the art will recognize that other channels or carriers may be utilized in addition to those illustrated, such as other traffic, control, and feedback channels.

### Block Diagrams

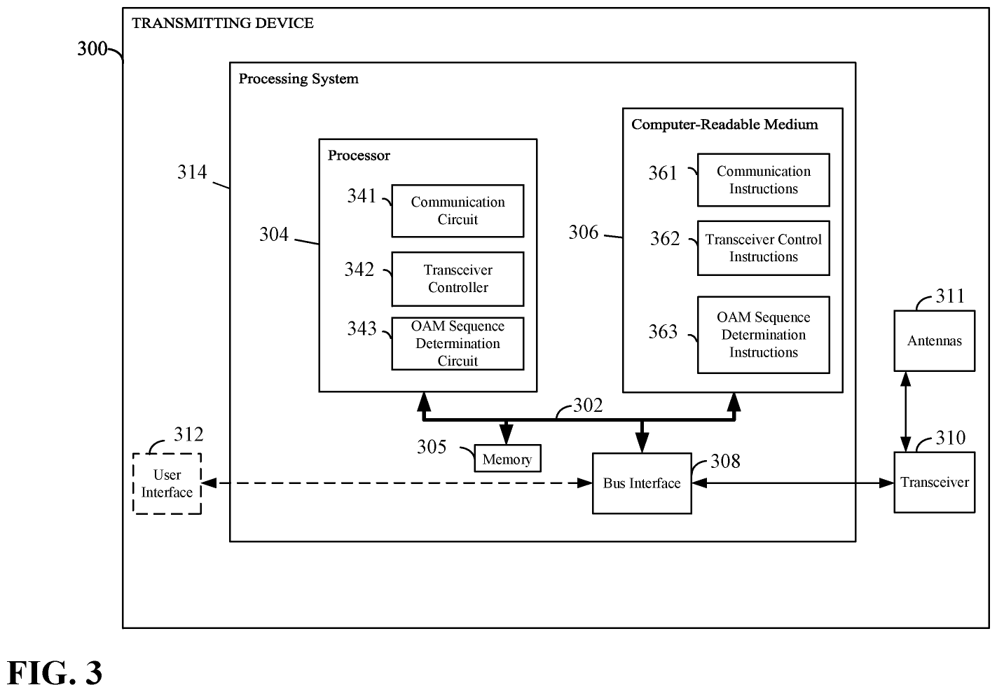

FIG. 3 is a block diagram illustrating an example of a hardware implementation for a transmitting device 300 employing a processing system 314. For example, the transmitting device 300 may be a user equipment (UE), a base station, or any other wireless communication node, e.g., as illustrated in any of FIGS. 1 and/or 2.

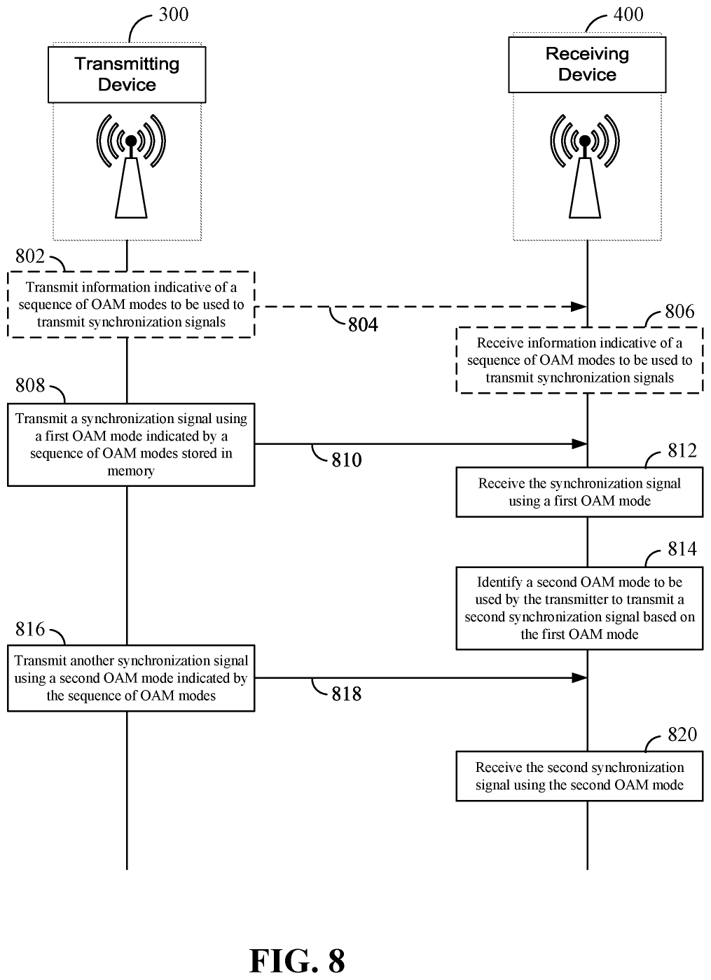

The transmitting device 300 may be implemented with a processing system 314 that includes one or more processors 304. Examples of processors 304 include microprocessors, microcontrollers, digital signal processors (DSPs), field programmable gate arrays (FPGAs), programmable logic devices (PLDs), application specific integrated circuits (ASICs), state machines, gated logic, discrete hardware circuits, and other suitable hardware configured to perform the various functionality described throughout this disclosure. In various examples, the transmitting device 300 may be configured to perform any one or more of the functions described herein. That is, the processor 304, as utilized in a transmitting device 300, may be configured (e.g., in coordination with the memory 305) to implement any one or more of the processes and procedures described below and illustrated in FIG. 8.

In this example, the processing system 314 may be implemented with a bus architecture, represented generally by the bus 302. The bus 302 may include any number of interconnecting buses and bridges depending on the specific application of the processing system 314 and the overall design constraints. The bus 302 communicatively couples together various circuits including one or more processors (represented generally by the processor 304), a memory 305, and computer-readable media (represented generally by the computer-readable medium 306). The bus 302 may also link various other circuits such as timing sources, peripherals, voltage regulators, and power management circuits, which are well known in the art, and therefore, will not be described any further. A bus interface 308 provides an interface between the bus 302 and a transceiver 310.

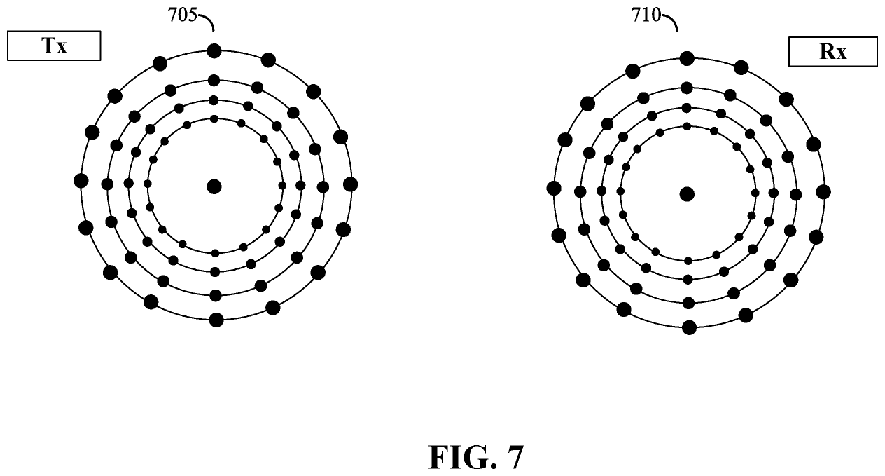

The transceiver 310 provides a communication interface or means for communicating with various other apparatus over a transmission medium. In some aspects, the transceiver 310 includes (or is coupled to) a plurality of antennas 311 (e.g., which may each include multiple antenna elements). The plurality of antennas 311 may be configured similar to the spiral phase plate (SPP) antennas described below and illustrated in FIG. 5; similar to the uniform circular array (UCA) antennas described below and illustrated in FIG. 6; similar to the coaxial multi-circle UCA configuration described below and illustrated in FIG. 7; or some combination of two or more of the above. In some aspects, any structures that enable OAM multiplexing of electromagnetic signals (e.g., RF signals, light signals, etc.) may apply, including but not limited to UCA antennas and SPP antennas, which are described as examples. The plurality of antennas 311 may include or otherwise be configured using any other suitably configured phase plates, spatial modulators, integrated circuits, any other suitable components, and/or any suitable combination thereof, for transmission over any suitable medium including a wireless air interface, an optical fiber, etc.

Depending upon the nature of the transmitting device 300, a user interface 312 (e.g., keypad, display, speaker, microphone, joystick) may also be provided. Of course, such a user interface 312 is optional, and may be omitted in some examples, such as a base station.

In some aspects of the disclosure, the processor 304 may include communication circuitry 341 configured (e.g., in coordination with the memory 305) for various functions, including, e.g., coordinating with a transceiver controller circuit 342 and/or transceiver controller instructions 362 to transmit suitable waveform to communicate information and/or transmit reference signals using one or more OAM modes. For example, the communication circuitry 341 may be configured to implement one or more of the functions described below in relation to FIG. 8, including, e.g., blocks 802, 808, and/or 816.

In some further aspects of the disclosure, the processor 304 may include a transceiver controller 342 configured (e.g., in coordination with the memory 305 and/or the transceiver 310) for various functions, including, e.g., transmitting a suitable waveform (e.g., information or data stream) and/or reference signal (e.g., DM-RS, CSI-RS, etc.) as disclosed herein. For example, the transceiver controller 342 may be configured to implement one or more of the functions described below in relation to FIG. 8, including, e.g., blocks 802, 808, and/or 816.

In some further aspects of the disclosure, the processor 304 may include orbital angular momentum (OAM) sequence determination circuitry 343 configured (e.g., in coordination with the memory 305) for various functions, including, e.g., determining which OAM mode(s) to use to transmit particular reference signals (e.g., synchronizing signals). In some examples, the OAM sequence determination circuitry 343 may determine which OAM mode is to be used to transmit reference signals based on an SSB index associated with resources in information indicative of a sequence of OAM modes to be used to transmit synchronization signals; in some additional examples, the OAM sequence determination circuitry 343 may use information stored in memory to determine which OAM mode to use to transmit a reference signal associated with a particular SSB index. For example, the OAM sequence determination circuitry 343 may be configured to implement one or more of the functions described below in relation to FIG. 8, including, e.g., blocks 802, 808, and/or 816.

The processor 304 is responsible for managing the bus 302 and general processing, including the execution of software stored on the computer-readable medium 306. The software, when executed by the processor 304, causes the processing system 314 to perform the various functions described below for any particular apparatus. The computer-readable medium 306 and the memory 305 may also be used for storing data that is manipulated by the processor 304 when executing software.

One or more processors 304 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 306. The computer-readable medium 306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 306 may reside in the processing system 314, external to the processing system 314, or distributed across multiple entities including the processing system 314. The computer-readable medium 306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 306 may store computer-executable code that includes communication instructions 361 that configure a transmitting device 300 for various functions, including, e.g., receiving an information stream (e.g., a sequence of bits) for transmission, and coordinating with a transceiver controller circuit 342 and/or transceiver controller instructions 362 to transmit a suitable waveform. For example, the communication instructions 361 may be configured to cause a transmitting device 300 to implement one or more of the functions described below in relation to FIG. 8, including, e.g., blocks 802, 808, and/or 816.

In one or more further examples, the computer-readable storage medium 306 may store computer-executable code that includes transceiver controller instructions 362 that configure a transmitting device 300 for various functions, including, e.g., transmitting a suitable waveform (e.g., information or data stream) and/or reference signal (e.g., DM-RS, CSI-RS, etc.) as disclosed herein. For example, the transceiver controller instructions 362 may be configured to cause a transmitting device 300 to implement one or more of the functions described below in relation to FIG. 8, including, e.g., blocks 802, 808, and/or 816.

In one or more further examples, the computer-readable storage medium 306 may store computer-executable code that includes OAM sequence determination instructions 363 that configure a transmitting device 300 for various functions, including, e.g., determining which OAM mode(s) to use to transmit particular reference signals (e.g., synchronizing signals). In some examples, the OAM sequence determination instructions 363 may determine which OAM mode is to be used to transmit reference signals based on an SSB index associated with resources in information indicative of a sequence of OAM modes to be used to transmit synchronization signals; in some additional examples, the OAM sequence determination instructions 363 may use information stored in memory to determine which OAM mode to use to transmit a reference signal associated with a particular SSB index. For example, the OAM sequence determination instructions 363 may be configured to implement one or more of the functions described below in relation to FIG. 8, including, e.g., blocks 802, 808, and/or 816.

In one configuration, the transmitting device 300 for wireless communication includes means for transmitting information indicative of a sequence of OAM modes to be used to transmit synchronization signals, including a first OAM mode and a second OAM mode, means for transmitting a first reference signal(s) on the first OAM mode using first resources in accordance with the sequence; means for transmitting a second reference signal on the second OAM mode using second resources in accordance with the sequence; means for transmitting a system information block including the information indicative of the sequence of OAM modes to be used to transmit the synchronization signals; and/or means for determining that the second OAM mode is to be used to transmit the second reference signal based on an SSB index associated with the second resources in the information indicative of the sequence of OAM modes to be used to transmit synchronization signals. In one aspect, the aforementioned means may be the processor 304 shown in FIG. 3 configured to perform the functions recited by the aforementioned means. In another aspect, the aforementioned means may be a circuit or any apparatus configured to perform the functions recited by the aforementioned means.

Of course, in the above examples, the circuitry included in the processor 304 is merely provided as an example, and other means for carrying out the described functions may be included within various aspects of the present disclosure, including but not limited to the instructions stored in the computer-readable storage medium 306, or any other suitable apparatus or means described in any one of the FIGS. 1, 2, 5, 6, and/or 7, and utilizing, for example, the processes and/or algorithms described herein in relation to FIG. 8.

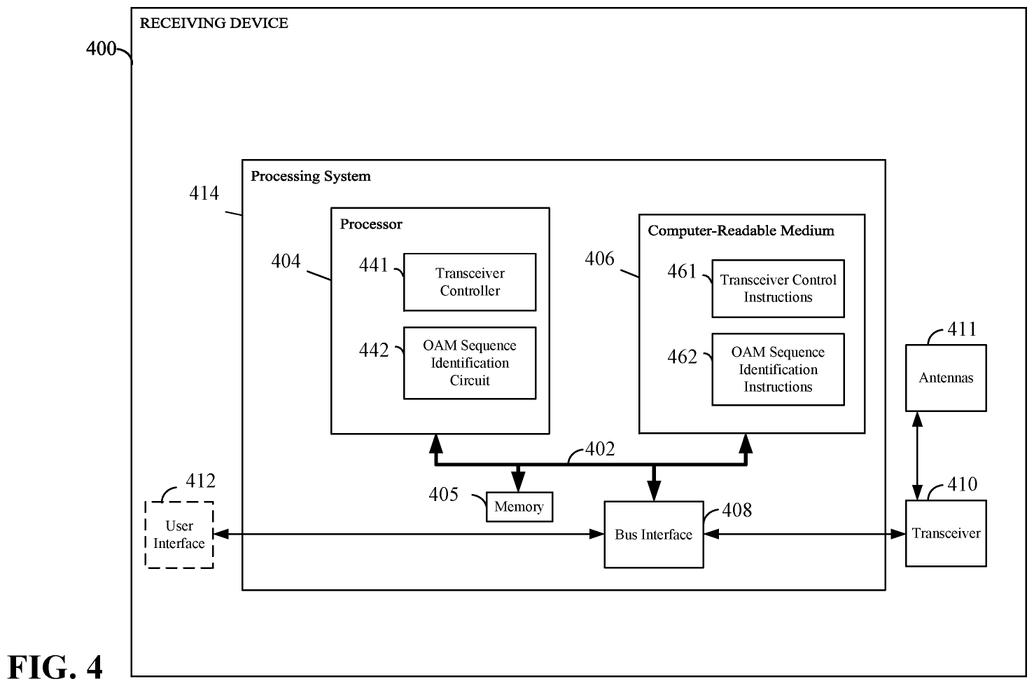

FIG. 4 is a conceptual diagram illustrating an example of a hardware implementation for an exemplary receiving device 400 employing a processing system 414. In accordance with various aspects of the disclosure, an element, or any portion of an element, or any combination of elements may be implemented with a processing system 414 that includes one or more processors 404. For example, the receiving device 400 may be a user equipment (UE), a base station, or any other suitable wireless communication node, e.g., as illustrated in any of FIGS. 1 and/or 2.

In some aspects, the transceiver 410 includes (or is coupled to) a plurality of antennas 411. (e.g., which may each include multiple antenna elements) The plurality of antennas 411 may be configured similar to the spiral phase plate (SPP) antennas described below and illustrated in FIG. 5; similar to the uniform circular array (UCA) antennas described below and illustrated in FIG. 6; similar to the coaxial multi-circle UCA configuration described below and illustrated in FIG. 7; or some combination of two or more of the above. In some aspects, any structures that enable OAM multiplexing of electromagnetic signals (e.g., RF signals, light signals, etc.) may apply, including but not limited to UCA antennas and SPP antennas, which are described as examples. The plurality of antennas 411 may include or otherwise be configured using any other suitably configured phase plates, spatial modulators, integrated circuits, any other suitable components, and/or any suitable combination thereof, for transmission over any suitable medium including a wireless air interface, an optical fiber, etc.

The processing system 414 may be substantially the same as the processing system 314 illustrated in FIG. 3, including a bus interface 408, a bus 402, memory 405, a processor 404, and a computer-readable medium 406. Furthermore, the receiving device 400 may include a user interface 412, and a transceiver 410 substantially similar to those described above in FIG. 3. That is, the processor 404, as utilized in a receiving device 400, may be configured (e.g., in coordination with the memory 405) to implement any one or more of the processes described below and illustrated in FIG. 8.

In some aspects of the disclosure, the processor 404 may include a transceiver controller 441 configured (e.g., in coordination with the memory 405) for various functions, including, for example, receiving and sampling a waveform (in some examples, including one or more reference signals), and storing samples of the received waveform in memory 405. For example, the transceiver controller 441 may be configured to implement one or more of the functions described below in relation to FIG. 8, including, e.g., blocks 806, 812, and/or 820.

In some further aspects of the disclosure, the processor 404 may include OAM sequence identification circuitry 442 configured (e.g., in coordination with the memory 405) for various functions, including, for example, identifying an OAM mode to be used by a transmitter to transmit a particular synchronization signal (e.g., a second synchronization signal) based on an OAM mode used to transmit a prior synchronization signal (e.g., a first synchronization signal). In some examples, the OAM sequence identification circuitry 442 may determine an SSB index associated with a first OAM mode based on information stored in memory, and identify a second OAM mode based on an SSB index associated with the second resources in the information stored in memory. For example, the OAM sequence identificationcircuitry 442 may be configured to implement one or more of the functions described below in relation to FIG. 8, including, e.g., block 814.

And further, the computer-readable storage medium 406 may store computer-executable code that includes transceiver controller instructions 461 that configure a receiving device 400 for various functions, including, e.g., receiving and sampling a waveform (in some examples, including one or more reference signals), and storing samples of the received waveform in memory 405. For example, the transceiver controller instructions 461 may be configured to cause a receiving device 400 to implement one or more of the functions described below in relation to FIG. 8, including, e.g., blocks 806, 812, and/or 820.

In some further examples, the computer-readable storage medium 406 may store computer-executable code that includes OAM sequence identification instructions 462 that configure a receiving device 400 for various functions, including, e.g., identifying an OAM mode to be used by a transmitter to transmit a particular synchronization signal (e.g., a second synchronization signal) based on an OAM mode used to transmit a prior synchronization signal (e.g., a first synchronization signal). In some examples, the OAM sequence identification instructions 462 may determine an SSB index associated with a first OAM mode based on information stored in memory, and identify a second OAM mode based on an SSB index associated with the second resources in the information stored in memory. For example, the OAM sequence identification instructions 462 may be configured to implement one or more of the functions described below in relation to FIG. 8, including, e.g., block 814.

In one configuration, the receiving device 400 for wireless communication includes means for receiving a first reference signal on a first OAM mode using first resources; means for identifying a second OAM mode to be used to receive a second reference signal associated with second resources; means for receiving the second reference signal on the second OAM mode using the second resources; means for determining an SSB index associated with the first OAM mode based on information stored in memory; means for identifying the second OAM mode based on an SSB index associated with the second resources in the information stored in memory; and/or means for receiving the information indicative of the sequence of OAM modes to be used to receive the synchronization signals. In one aspect, the aforementioned means may be the processor 404 shown in FIG. 4 configured to perform the functions recited by the aforementioned means. In another aspect, the aforementioned means may be a circuit or any apparatus configured to perform the functions recited by the aforementioned means.

Of course, in the above examples, the circuitry included in the processor 404 is merely provided as an example, and other means for carrying out the described functions may be included within various aspects of the present disclosure, including but not limited to the instructions stored in the computer-readable storage medium 406, or any other suitable FIGS. 1, 2, 5, 6, and/or 7, and utilizing, for example, the processes and/or algorithms described herein in relation to FIG. 8.

In some aspects, this disclosure provides for a wireless communication technique that exploits an orbital angular momentum (OAM) property of electromagnetic (EM) waves for modulating a carrier to carry information, and/or for multiplexing reference signals onto a common wireless resource. Systems and devices that employ OAM are currently under intense development due to its improved communication spectrum efficiency, its capability to provide high-order spatial multiplexing (e.g., as described further below), potentially resulting in higher data rates, and the possibility to enable low receiver complexity, OAM is regarded as a strong candidate for future 6G communication technology or as an enhancement to existing 5G technology.

### SPP Configuration

FIG. 5 illustrates an example of a spiral phase plate (SPP) OAM configuration that supports information transmission by OAM mode selection and detection in accordance with some aspects of the present disclosure. In some examples, the illustrated SPP OAM configuration may implement aspects of RAN 100, and may be employed by the transmitting device 202/300 and receiving device 206/400. In this example, a transmitting device (e.g., UE or base station) may include transmitter OAM components 505 and a receiving device (e.g., UE or base station) may include receiver OAM components 510.

In cases in which wireless devices use an SPP methodology, a transmitting device may convert an EM wave 515 associated with an OAM mode index l=0 (e.g., a non-helical EM wave associated with mode-zero OAM) into an EM wave associated with an OAM mode index l≠0 (e.g., a helical EM wave associated with a non-zero OAM mode) by passing the EM wave through an aperture 520 and an SPP 525. Such an SPP 525 may have a suitable structure and/or configuration, known to those skilled in the art, to generate an EM wave associated with a single OAM mode. Thus, the wireless device may use one SPP 525 to generate one OAM mode of an OAM beam 535. As such, a wireless device may implement a different SPP 525 for each OAM mode of an OAM beam 535.

In the example of FIG. 5, two OAM modes may be used (e.g., l=+1 and −1). In the transmitter OAM components, a first EM wave 515-a may be provided to a first aperture 520-a and a first SPP 525-a, and a second EM wave 515-b may be provided to a second aperture 520-b and a second SPP 525-b. A beam splitter/combiner 550 may combine the output of the first SPP 525-a and the second SPP 525-b to generate OAM beam 535. The receiver OAM components 510 may receive the OAM beam 535 at a beam splitter/combiner 540 to provide instances of the OAM beam 535 to a third SPP 525-c and a fourth SPP 525-d that provide output to a first receiver aperture 520-c and a second receiver aperture 520-d, respectively. In general, a receiving device includes a separate SPP and receiver aperture for each OAM mode. Thus, the third SPP 525-c may be configured recover the OAM mode corresponding to the first SPP 525-a, and thus, the output of the first receiver aperture 520-c may correspond to the first EM wave 515-a (e.g., for OAM Mode l=1). Likewise, the fourth SPP 525-d may be configured to recover the OAM mode corresponding to the second SPP 525-b, and thus, the output of the second receiver aperture 520-d may correspond to the second EM wave 515-b (e.g., for OAM Mode l=2). In devices that use an SPP methodology, separate SPPs 525-a may thus be used for each OAM mode, and the number of SPPs 525 at a device may constrain the number of usable OAM modes. As described below, wireless devices may also use a UCA methodology for OAM communications, an example of which is discussed with reference to FIG. 6.

### UCA Configuration

FIG. 6 illustrates an example of a uniform circular array (UCA) OAM configuration that supports information transmission by OAM mode selection and detection in accordance with some aspects of the present disclosure. In some examples, the illustrated UCA OAM configuration may implement aspects of RAN 100, and may be employed by the transmitting device 202/300 and receiving device 206/400. In this example, a transmitting device (e.g., UE or base station) may include OAM transmitter UCA antennas 605 and a receiving device (e.g., UE or base station) may include OAM receiver UCA antennas 610.

In some aspects, one or both of the OAM transmitter UCA antennas 605 or the OAM receiver UCA antennas 610 may be implemented as a planar array of antenna elements, which may be an example of or otherwise function as a (massive or holographic) MIMO array or an intelligent surface. In some cases, the transmitting device may identify a set of antenna elements 615 of the planar array that form a transmitter UCA, and a receiving device may identify a set of antenna elements 645 of the planar array that form a receiver UCA.

Upon selecting the set of antenna elements from the planar array, the OAM transmitter may apply a weight 635 to each of the selected antenna elements 615 based on the OAM mode index l of the transmitted OAM beam and one or more spatial parameters associated with each antenna element. In cases in which a UCA methodology is used to generate an OAM beam, the transmitting device may identify the set of antenna elements 615 on a circular array of antenna elements and may load a first set of weights 620 to each of the identified antenna elements based on a first OAM mode index (e.g., l=0). Further, for other OAM mode indices, other weights may be used for the set of antenna elements 615, such as a second OAM mode index (e.g., l=+1) that may use a second set of weights 625 and a third OAM mode index (e.g., l=−1) that may use a third set of weights 630.

For example, to generate an OAM beam with a selected OAM mode index (e.g., l=0), an OAM transmitter may load a weight 635 to each antenna element 615 on the UCA based on an angle 640 measured between a reference line on the UCA (e.g., the x-axis of the plane on which the UCA is located, where the origin is at the center of the UCA) and the antenna element, the OAM mode index l, and i (e.g., for complex-valued weights, which may alternatively be denoted as j in some cases). In some cases, for instance, the weight for an antenna element n may be proportional to e^{ilφ}^{ₙ}, where φₙ is equal to the angle 640 measured between the reference line on the UCA and the antenna element n. By multiplying respective beamforming weights 635 of each set of weights 620-630 (e.g., for first set of weights 620, w₁=[w_{1,1}, w_{1,2}, . . . , w_{1,8}]^{T}) onto each antenna, a signal port may be generated. If the weight 635 of each antenna 615 is equal to e^{iφl}, where φ is the angle of antenna 615 in the circle (e.g., angle 640 for antenna element 615-g), and l is the OAM mode index, then each set of weights 620-630 provides a beamformed port that is equivalent OAM mode l. By using different beamforming weights e^{iφl′}, where l′≠l, multiple OAM modes are thus generated.

At the OAM receiver UCA antennas 610, the receiving device may have receive antenna elements 645 equipped in a circle. The channel matrix may be denoted from each transmit antenna to each receive antenna as H, and then for the beamformed channel matrix \tilde{H}=H[w₁, w₂, . . . , w_{L}], any two columns of \tilde{H} are orthogonal, which means the beamformed ports have no crosstalk. This may allow OAM-based communication to efficiently realize a high-level spatial multiplexing degree. Further, the eigen-based transmit precoding weights and receive combining weights of UCA-based OAM are equal to a discrete Fourier transform (DFT) matrix, which is independent of communication parameters (e.g., distance, aperture size, and carrier frequency). Thus, UCA-based OAM may be implemented at relatively low cost. In some cases, the receiving device may test multiple different OAM modes to determine the OAM mode that was used in a transmission (e.g., based on whether a particular OAM mode yields a successfully demodulated transmission), which may be used to identify one or more information bits of a transmission.

In some aspects, when the central axes of the transmitter antennas (e.g., the antennas 311) and receiver antennas (e.g., the antennas 411) are closely aligned (e.g., with less than 0.1 milliradians (mrad) of misalignment), each OAM mode is orthogonal to each other OAM mode. However, as the antennas become misaligned, neighboring OAM modes may cause interference. For example, at 1 mrad of misalignment, an adjacent OAM mode may cause significant interference, and at larger misalignments, OAM modes that are father from a particular OAM mode may also cause interference.

### Multiple Coaxial UCA Configuration

FIG. 7 illustrates an example of a coaxial multi-circle UCA OAM configuration that supports multiplexing and modulating wireless transmissions by controlling OAM modes and coaxial UCA circles in accordance with some aspects of the present disclosure. In some examples, the illustrated coaxial multi-circle UCA OAM configuration may implement aspects of RAN 100, and may be employed by the transmitting device 202/300 and receiving device 206/400. In this example, a transmitting device (e.g., UE or base station) may include OAM transmitter UCA antennas 705 and a receiving device (e.g., UE or base station) may include OAM receiver UCA antennas 710.

In some aspects, one or both of the OAM transmitter coaxial multi-circle UCA antennas 705 or the OAM receiver coaxial multi-circle UCA antennas 710 may be implemented as a planar array of coaxial UCA antenna elements as described above and illustrated in FIG. 6. In various examples, an OAM transmitter may include the same number of UCA circles as an OAM receiver, but this is not necessarily the case. That is, a transmitting device 202/300 can communicate with a receiving device 206/400 with the same number and with a different number of UCA circles.

According to a further aspect of the present disclosure, a transmitting device may employ a subset (e.g., one or more) of its UCA circles from its transmitter UCA antennas 705 for a given transmission. For example, a transmitting device may multiplex a plurality of beams, streams, or waveforms onto a given wireless resource by transmitting each such stream with a different respective set of one or more UCA circles. Theoretically, streams transmitted via different sets of UCA circles can be orthogonal, such that a receiving device can receive and separately recover these streams received over the same radio resource (e.g., overlapping in the time- and frequency-domains, using the same code, etc.).

In a further aspect, a transmitting device may independently select or control an OAM mode for each of the plurality of multiplexed OAM beams. That is, a transmitting device may utilize a first set of one or more UCA circles to transmit a first OAM beam having a first OAM mode, and a second set of one or more UCA circles to transmit a second OAM beam having a second OAM mode. Here, the first OAM mode (i.e., from the first set of one or more UCA circles) may be the same as, or different from the second OAM mode (i.e., from the second set of one or more UCA circles). Various options and further details of such a system are provided in the discussion that follows.

In the description that follows, for ease of description, reference is made to a UCA configuration such as the ones illustrated in FIGS. 6 and 7. However, it is to be understood that the present disclosure is not limited thereto. That is, according to another aspect of this disclosure, reference signal multiplexing using multiple OAM modes may be implemented utilizing an SPP configuration as described above and illustrated in FIG. 5. Additionally, according to other aspects of this disclosure, reference signal multiplexing using multiple OAM modes may be implemented using any structures that enable OAM multiplexing of electromagnetic signals (e.g., RF signals, light signals, etc.) may apply, including but not limited to UCA antennas and SPP antennas, which are described as examples. Signals transmitted (e.g., multiplexed) using multiple OAM modes may be transmitted and/or received using any suitable transmitting components and/or receiving components, which may include or otherwise be configured using any suitably configured phase plates, spatial modulators, integrated circuits, any other suitable components, and/or any suitable combination thereof, for transmission over any suitable medium including a wireless air interface, an optical fiber, etc.

### Synchronization Signal Block Transmission and Reception Sequencing

FIG. 8 is a call flow diagram illustrating an example process for transmitting and receiving synchronization signal blocks (SSBs) using a reference signal sequence indication in accordance with some aspects of this disclosure. As described below, some or all illustrated features may be omitted in a particular implementation within the scope of the present disclosure, and some illustrated features may not be required for implementation of all embodiments. In some examples, the process illustrated in FIG. 8 may be carried out by the transmitting device 300 illustrated in FIG. 3 and the receiving device 400 illustrated in FIG. 4. In some examples, the process of FIG. 8 may be carried out by any suitable apparatus or means for carrying out the functions or algorithm described below.

At block 802, a transmitting device (e.g., transmitting device 300) may transmit a signal 804 (e.g., a waveform) that includes information indicative of a sequence of orbital angular momentum (OAM) modes to be used to transmit reference signals (e.g., synchronization signals or an SSB). For example, in some aspects, the transmitting device 300 may transmit the information on any suitable channel (e.g., any suitable physical layer channel, such as PDCCH, PUCCH, or PSCCH) via any suitable communication network (e.g., via a RAN, such as RAN 200, and/or via D2D connection, using one or more DL slots, one or more UL slots, one or more SL slots, etc.). In some aspects, the transmitting device 300 may transmit the information using any suitable communication interface, such as a transceiver (e.g., transceiver 310) and antennas (e.g., antennas 311). For example, in some aspects, the transmitting device 300 may transmit signal 804 using a particular OAM mode. As another example, the transmitting device 300 may transmit signal 804 using any other suitable communication technique(s).

In some aspects, the transmitting device 300 may transmit a list, a table, values, etc., indicative of which OAM modes are to be used to transmit reference signals. Such reference signals may include synchronization reference signals (e.g., PSS and/or SSS), and/or may be associated with information that can be used to receive information from the transmitter (e.g., PBCH). In some aspects, reference signals and/or information transmitted in an SSB may be used by a receiving device to synchronize with the transmitting device, estimate a channel used to transmit signals associated with the transmitter, receive system information (e.g., in a master information block (MIB) and/or one or more system information blocks (SIBs), such as a system information block type 1 (SIB1)), etc.

In some aspects, the transmitting device 300 may retrieve the information indicative of the sequence of OAM modes from memory (e.g., memory 305). For example, the transmitting device 300 may generate the information indicative of the sequence of OAM modes, and store the resulting information in memory. As another example, the transmitting device 300 may receive the information indicative of the sequence of OAM modes from another device (e.g., a base station, a core network, a server configured to provide software updates, etc.). In a more particular example, the information indicative of the sequence of OAM modes may be defined in a communication standard or specification, and the transmitting device 300 may receive the information indicative of the sequence of OAM modes during a setup and/or update procedure.

In some aspects, the transmitting device 300 may transmit the information indicative of the sequence of OAM modes to be used to transmit SSBs on any suitable channel (e.g., any suitable physical layer channel, such as the physical downlink control channel (PDCCH), the physical uplink control channel (PUCCH), or the physical sidelink control channel (PSCCH)) via any suitable communication network (e.g., via a RAN, such as RAN 200, and/or via a device-to-device (D2D) connection), using one or more downlink (DL) slots, one or more uplink (UL) slots, one or more sidelink (SL) slots, etc.). In some aspects, the transmitting device can transmit the SSB using any suitable communication interface, such as a transceiver (e.g., transceiver 310) and antennas (e.g., antennas 311).

In some aspects, the transmitting device 300 may transmit the information indicative of the sequence of OAM modes to be used to transmit SSBs in a MIB and/or in one or more SIBs (e.g., in SIB1) associated with an SSB. Additionally or alternatively, in some aspects, the transmitting device 300 may transmit information indicative of the sequence of OAM modes with any other suitable system information.

In some aspects, the information indicative of the sequence of OAM modes to be used to transmit SSBs may include any suitable information useable to determine which SSB index is associated with a particular OAM mode, and/or which OAM mode is associated with a particular SSB index.

In some aspects, the information indicative of the sequence of OAM modes to be used to transmit SSBs may be formatted as a list of OAM modes. For example, the list can be formatted as a series of values, (i₁, i₂, . . . , i_{N}) each corresponding to an OAM mode l∈ [symbol] (e.g., any integer). In such an example, a first element may identify an OAM mode used to transmit a first SSB index (e.g., SSB index 0), a second element may identify an OAM mode used to transmit a second SSB index (e.g., SSB index 1), and so on. As another example, the list can be formatted as a series of values, (i₁, j₁, i₂, j₂ . . . , i_{N}, j_{N}), where each value iₙ corresponds to an OAM mode l∈ [symbol] (e.g., any integer), and each value jₙ corresponds to an SSB index within a set of SSB set. In some aspects, the information indicative of the sequence of OAM modes to be used to transmit SSBs may be formatted as a table of OAM modes and corresponding SSB indexes. In some aspects, if all SSB indexes are included, the list can be formatted as a series of values, (i₁, i₂, . . . , i_{N}), where each value iₙ corresponds to an OAM mode l∈ [symbol] (e.g., any integer) that is associated with SSB index n.

In some aspects, the information indicative of the sequence of OAM modes to be used to transmit SSBs may be formatted as a value(s) from which the sequence may be derived. For example, the information indicative of the sequence of OAM modes may include a mode number of a starting mode. In such an example, the starting mode may be a value N that indicates a magnitude of OAM mode that is to be associated with an initial SSB index (e.g., SSB index 0). In some aspects, the value may be signed or unsigned. For example, the starting value can be an unsigned integer N, and the transmitting device 300 and receiving device (e.g., receiving device 400) can be configured to start at a particular handedness of the OAM mode (e.g., left-handed having a negative OAM mode, or right-handed having a positive OAM mode). As another example, the starting value can be a signed integer N or −N.

In some aspects, the number of SSB indexes in a set of SSBs may be explicitly defined using a value included in the information indicative of the sequence of OAM modes to be used to transmit SSBs. For example, the information can include a length value, which may be used to indicate a total number of SSBs to be transmitted and/or a maximum SBS index. In such an example, a length value may be transmitted, where the length value may be 2|N|+1 (or any other suitable value). This may indicate that there are a total of 2|N|+1 SSB indexes in the set of SSBs are to be transmitted by the transmitter device 300, such that modes [−N, . . . , −1,0,1, . . . , N] are used to transmit SSBs with indexes [0, . . . 2N].

As another example, the information can include a maximum index value. In such an example, a maximum index value may be transmitted, where the maximum may be 2|N| (or any other suitable value). This may indicate that a total of 2|N|+1 SSB indexes in the set of SSBs are to be transmitted by the transmitter device 300 (e.g., starting or ending with an SSB index of 0).

In some aspects, the information indicative of the sequence of OAM modes to be used to transmit SSBs may include both a starting value (e.g., −N, or an unsigned value N) and a length or maximum. In such aspects, a different number of positive and negative OAM modes may be used to transmit SSBs. For example, for a starting value −N, if the length is greater than 2|N|+1 or the maximum SSB index is greater than 2|N|, the number of positive OAM modes used is greater than the number of negative modes. As another example, for a starting value −N, if the length is less than 2|N|+1 or the maximum SSB index is less than 2|N|, the number of negative OAM modes used is greater than the number of positive modes.

In some aspects, the number of SSB indexes in a set of SSBs may be inferred based on the starting value. For example, transmitter device 300 (and/or receiving device 400) may determine the total number of SSBs based on the starting value. In a more particular example, for a starting value of N (which may correspond to a positive or negative OAM mode), transmitter device 300 (and/or receiving device 400) may determine that the number of SSB index values is 2|N|+1 (e.g., the SBB indexes associated with the set of SSBs may go from 0 to 2|N|).

In some aspects, the starting value may be inferred based on the length of the SSB index or the maximum SSB index value. For example, transmitter device 300 (and/or receiving device 400) may determine that the starting OAM mode is

$$\\ N = \frac{length - 1}{2} or N = \frac{{SSB}_{max}}{2} .$$

In some aspects, the transmitting device 300 may transmit the information indicative of the sequence of OAM modes to be used to transmit SSBs using any suitable resources (e.g., any suitable time-frequency resources, using any suitable resource element(s)). In some aspects, the transmitting device 300 may transmit the signal 804 using wireless resources associated with system information. For example, signal 804 may be used to transmit an SSB, including the information indicative of the sequence of OAM modes to be used to transmit SSBs. In such an example, the information indicative of the sequence of OAM modes to be used to transmit SSBs may be included in system information (e.g., in a MIB, in a SIB1, etc.).

In some aspects, transmission of the information indicative of the sequence of OAM modes to be used to transmit SSBs at block 802 can be omitted and/or combined with another operation(s) of the transmitter device 300. For example, where information indicative of the sequence of OAM modes to be used to transmit SSBs is defined by a communication standard, transmission of such information can be omitted. As another example, transmission of the information indicative of the sequence of OAM modes to be used to transmit SSBs may be performed in parallel with transmission of one or more SSBs (e.g., as described below in connection with block 808). As yet another example, transmission of the information indicative of the sequence of OAM modes to be used to transmit SSBs by the transmitter device 300 may be omitted where another device provides such information to the receiver device.

In some aspects, the transmitting device 300 may determine which OAM modes to use to transmit various reference signals using information stored in memory indicating which OAM modes are to be used to transmit reference signals associated with each SSB index. For example, the transmitting device 300 may determine which OAM mode is to be used to transmit reference signals based on information stored in memory, such as information indicative of a sequence of OAM modes to be used to transmit synchronization signals (e.g., information transmitted at block 802, information stored in memory, information specified by a communication standard such as 5G NR, etc.).

At block 806, a receiving device (e.g., the receiving device 400) may receive the signal 804 that includes information indicative of a sequence of OAM modes to be used to transmit synchronization signals. For example, in some aspects, the receiving device 400 may receive the information on any suitable channel (e.g., any suitable physical layer channel, such as PDCCH, PUCCH, or PSCCH) via any suitable communication network (e.g., via a RAN, such as RAN 200, and/or via D2D connection, using one or more DL slots, one or more UL slots, one or more SL slots, etc.). In some aspects, the receiving device may receive the signal 804 using any suitable communication interface, such as a transceiver (e.g., transceiver 410) and antennas (e.g., antennas 411). In some aspects, the receiving device can receive the signal 804 by sampling and buffering a received wireless signal on an appropriate channel, and applying suitable processing to the buffered signal such as energy detection, demodulation (e.g., using a demodulation function associated with the OAM mode used to transmit and receive the signal 804, and based on the channel matrix), decoding, etc.

In some aspects, the receiving device 400 may store the information received at block 806 in memory, and/or may store information derived from the invention received at block 806 in memory. For example, the receiving device 400 may store a list indicative of which OAM modes are to be used to transmit reference signals (e.g., as described above in connection with block 802). As another example, the receiving device 400 may store a table indicative of which OAM modes are to be used to transmit reference signals (e.g., as described above in connection with block 802). As yet another example, the receiving device 400 may store a value(s) indicative of which OAM modes are to be used to transmit reference signals (e.g., a starting value, a length, and/or a maximum SSB index, as described above in connection with block 802).

In some aspects, the receiving device 400 may use the information received at block 806 to generate a table of OAM modes and corresponding SSB indexes to be used to transmit synchronization signals from the transmitter device 300.

In some aspects, reception of the information indicative of the sequence of OAM modes to be used to transmit SSBs at block 806 can be omitted and/or combined with another operation(s) of the receiver device 400. For example, where information indicative of the sequence of OAM modes to be used to transmit SSBs is defined by a communication standard, reception of such information can be omitted. As another example, transmission of the information indicative of the sequence of OAM modes to be used to transmit SSBs may be performed in parallel with transmission of one or more SSBs (e.g., as described below in connection with block 812).

In some aspects, the receiving device 400 receiving and/or storing information indicative of a sequence of OAM modes to be used to transmit synchronization signals may reduce MIB overhead. For example, as described above, determining an SSB index in some communication standards (e.g., 5G NR) may include using information received in an MIB. Using mechanisms described herein, the information that is included in an MIB in 5G NR to facilitate identification of an SSB index may be omitted. As another example, determining an SSB index in some communication standards (e.g., 5G NR) may include determining an index of a DM-RS transmitted using PBCH. Using mechanisms described herein, an SSB index of a particular SSB may be identified without requiring successful demodulation of a DM-RS transmitted using PBCH.

At block 808, the transmitting device (e.g., transmitting device 300) may use a first OAM mode to transmit a signal 810 (e.g., a waveform) that includes one or more reference signals (e.g., synchronization signals), and which may or may not include additional information (e.g., system information). For example, in some aspects, the transmitting device 300 may transmit the reference signals on any suitable channel (e.g., any suitable physical layer channel, such as PDCCH, PUCCH, or PSCCH) via any suitable communication network (e.g., via a RAN, such as RAN 200, and/or via D2D connection, using one or more DL slots, one or more UL slots, one or more SL slots, etc.). In some aspects, the transmitting device 300 may transmit the information using any suitable communication interface, such as a transceiver (e.g., transceiver 310) and antenna(s) (e.g., antennas 311). In some embodiments, the antennas used to transmit the signal 810 may be configured as a UCA (e.g., as described above in connection with FIG. 6), and/or as a particular UCA circle (e.g., as described above in connection with FIG. 7).

In some aspects, the transmitting device 300 may determine, in connection with block 808, which OAM mode is to be used to transmit the reference signal at block 808 using information stored in memory indicating which OAM modes is to be used to transmit areference signal associated with each SSB index. For example, the transmitting device 300 may determine that the first OAM mode is to be used to transmit the signal 810 based on information stored in memory, such as information indicative of a sequence of OAM modes to be used to transmit synchronization signals (e.g., information transmitted at block 802, information stored in memory, information specified by a communication standard such as 5G NR, etc.).

In some aspects, the transmitting device 300 may transmit a primary synchronization signal (PSS), a secondary synchronization signal (SSS), a physical broadcast channel (PBCH), a demodulation reference signal (DM-RS), such as a DM-RS associated with the PBCH. In a more particular example, the transmitting device 300 may transmit a synchronization signal block (SSB) that includes a PSS, an SSS, and information and/or reference signals on PBCH.

In some aspects, the transmitting device 300 can transmit a MIB, SIB1, and/or one or more other SIBs using signal 810. For example, a MIB, SIB1, and/or one or more other SIBs can be included in an SSB transmitted at block 808 using signal 810.

As described above in connection with block 802, in some aspects, the transmitting device 300 may transmit the information indicative of a sequence of OAM modes to be used to transmit synchronization signals in connection with transmission of one or more synchronization signals at block 808.

At block 812, a receiving device (e.g., the receiving device 400) may receive the signal 810 that includes the synchronization signal(s) transmitted at block 808. For example, in some aspects, the receiving device 400 may receive the signal 810 on any suitable channel (e.g., any suitable physical layer channel, such as PDCCH, PUCCH, or PSCCH) via any suitable communication network (e.g., via a RAN, such as RAN 200, and/or via D2D connection, using one or more DL slots, one or more UL slots, one or more SL slots, etc.). In some aspects, the receiving device may receive the signal 810 using any suitable communication interface, such as a transceiver (e.g., transceiver 410) and antennas (e.g., antennas 411). In some aspects, the receiving device can receive the signal 810 by sampling and buffering a received wireless signal on an appropriate channel, and applying suitable processing to the buffered signal such as energy detection, demodulation (e.g., using a demodulation function associated with the first OAM mode, and based on the channel matrix), decoding, etc.

In some aspects, the receiving device 400 may attempt to blindly decode one or more portions of an SSB using an OAM mode (e.g., the first OAM mode) at block 812. For example, the receiving device 400 may attempt to blindly decode an SSB when the receiving device 400 is not synchronized with a transmitting device (e.g., transmitting device 300).

At block 814, the receiving device (e.g., the receiving device 400) may identify a second OAM mode to be used by the transmitter device to transmit a second synchronization signal based on the identify of the first OAM mode and the information indicative of the sequence of OAM modes to be used to transmit synchronization signals. In some aspects, the receiving device may determine the resources (e.g., time-frequency resources) to use to receive the second synchronization signal based on any suitable information. For example, the resources used to transmit synchronization signals (e.g., in an SSB) may be regulated by a communication standards (e.g., 5G NR). Additionally or alternatively, a transmitting device (e.g., the transmitting device 300) may provide information indicating resources to be used to transmit upcoming synchronization signals (e.g., in connection with one or more SSBs, such as an SSB transmitted at block 808).

For example, in some aspects, the receiving device 400 may use the information indicative of the sequence of OAM modes to be used to transmit synchronization signals to identify an OAM mode that the transmitting device is expected to use to transmit an upcoming synchronization signal. In such an example, the receiving device 400 may identify any suitable OAM mode, such as a next OAM mode to be used to transmit a next SSB.

At another example, the receiving device 400 may use the information indicative of the sequence of OAM modes to be used to transmit synchronization signals to identify an OAM mode that the transmitting device is expected to use to transmit a particular synchronization signal (e.g., associated with a particular SSB index and/or OAM mode). In such an example, the receiving device 400 may facilitate synchronization of a particular OAM mode based on an associated SSB index.

In some aspects, the receiving device 400 receiving and/or storing information indicative of a sequence of OAM modes to be used to transmit synchronization signals may reduce access latency for the first OAM mode. For example, the receiving device 400 may determine a frame index and slot of the SSB associated with the first OAM mode more quickly based on the SSB index associated with the first OAM mode.

In some aspects, the receiving device 400 receiving and/or storing information indicative of a sequence of OAM modes to be used to transmit synchronization signals may reduce access latency for one or more OAM modes. For example, the receiving device 400 may identify resources to be used to transmit SSBs for one or more other OAM modes based on the OAM mode used to transmit an SSB that was successfully decoded. This can facilitate synchronization of OAM modes with less searching (e.g., without attempting to blindly decode an SSB with the other OAM modes using different time-frequency resources). Additionally, this can facilitate faster identification of a better or best OAM mode to use to receive signals from the OAM transmitter, as the receiving device 400 may more quickly identify the timing of SSBs for each OAM mode based on a determination that the first OAM mode was used to receive the SSB transmitted at block 808.

At block 816, the transmitting device (e.g., transmitting device 300) may use a second OAM mode (which or may not be a numerically next OAM mode that follows the first OAM mode in the sequence) to transmit a signal 818 (e.g., a waveform) that includes one or more reference signals (e.g., synchronization signals), and which may or may not include additional information (e.g., system information). For example, in some aspects, the transmitting device 300 may transmit the reference signals on any suitable channel (e.g., any suitable physical layer channel, such as PDCCH, PUCCH, or PSCCH) via any suitable communication network (e.g., via a RAN, such as RAN 200, and/or via D2D connection, using one or more DL slots, one or more UL slots, one or more SL slots, etc.). In some aspects, the transmitting device 300 can transmit the information using any suitable communication interface, such as a transceiver (e.g., transceiver 310) and antenna(s) (e.g., antennas 311). In some embodiments, the antenna elements used to transmit the signal 810 can be configured as a UCA (e.g., as described above in connection with FIG. 6), and/or as a particular UCA circle (e.g., as described above in connection with FIG. 7).

In some aspects, the transmitting device 300 may determine, in connection with block 816, which OAM mode is to be used to transmit the reference signal at block 816 using information stored in memory indicating which OAM modes is to be used to transmit areference signal associated with each SSB index. For example, the transmitting device 300 may determine that the first OAM mode is to be used to transmit the signal 818 based on information stored in memory, such as information indicative of a sequence of OAM modes to be used to transmit synchronization signals (e.g., information transmitted at block 802, information stored in memory, information specified by a communication standard such as 5G NR, etc.).

In some aspects, the transmitting device 300 may transmit a primary synchronization signal (PSS), a secondary synchronization signal (SSS), a physical broadcast channel (PBCH), a demodulation reference signal (DM-RS), such as a DM-RS associated with the PBCH. In a more particular example, the transmitting device 300 may transmit a synchronization signal block (SSB) that includes a PSS, an SSS, and information and/or reference signals on PBCH.

In some aspects, the transmitting device 300 can transmit a MIB, SIB1, and/or one or more other SIBs using signal 810. For example, a MIB, SIB1, and/or one or more other SIBs can be included in an SSB transmitted at block 808 using signal 810.

As described above in connection with block 802, in some aspects, the transmitting device 300 may transmit the information indicative of a sequence of OAM modes to be used to transmit synchronization signals in connection with transmission of one or more synchronization signals at block 816.

In some aspects, the receiving device 400 may identify resources to be used to transmit the synchronization signals associated with the second OAM mode based on the sequence of OAM modes, the SSB index associated with the second OAM mode, and/or information related to the timing of synchronization signal transmissions (e.g., as defined in a communication standard with which the transmitting device and/or receiving device comply).

At block 820, a receiving device (e.g., the receiving device 400) may receive the signal 818 that includes the synchronization signal(s) transmitted at block 816. For example, in some aspects, the receiving device 400 may receive the signal 818 on any suitable channel (e.g., any suitable physical layer channel, such as PDCCH, PUCCH, or PSCCH) via any suitable communication network (e.g., via a RAN, such as RAN 200, and/or via D2D connection, using one or more DL slots, one or more UL slots, one or more SL slots, etc.). In some aspects, the receiving device may receive the signal 810 using any suitable communication interface, such as a transceiver (e.g., transceiver 410) and antennas (e.g., antennas 411). In some aspects, the receiving device can receive the signal 818 by sampling and buffering a received wireless signal on an appropriate channel, and applying suitable processing to the buffered signal such as energy detection, demodulation (e.g., using a demodulation function associated with the first OAM mode, and based on the channel matrix), decoding, etc.

In some aspects, the receiving device 400 may receive and decode one or more portions of an SSB using the second OAM mode at block 820. For example, the receiving device 400 may attempt to receive and decode an SSB using the second OAM mode based on the identification of the first mode at 814 and the sequence to be used to transmit the OAM modes.

### Further Examples Having a Variety of Features

Implementation examples are described in the following numbered clauses:

1. An apparatus configured for wireless communication, comprising: a processor; a plurality of antenna elements; a transceiver coupled to the processor and to plurality of antenna elements; and a memory coupled to the processor, wherein the processor and the memory are configured to: receive, via the transceiver and a first antenna element of the plurality of antenna elements, a first reference signal on a first orbital angular momentum (OAM) mode using first resources; identify, based on the first OAM mode used to receive the first reference signal, a second OAM mode to be used to receive a second reference signal associated with second resources; and receive, via the transceiver and the first antenna element of the plurality of antenna elements, the second reference signal on the second OAM mode using the second resources.

2. The apparatus of clause 1, wherein the first reference signal is included in a synchronization signal block (SSB).

3. The apparatus of clause 2, wherein the processor and the memory are further configured to: determine an SSB index associated with the first OAM mode based on information stored in memory; and identify the second OAM mode based on an SSB index associated with the second resources in the information stored in memory.

4. The apparatus of any one of clauses 1 to 3, wherein each of a plurality of OAM modes is associated with not more than one synchronization signal block (SSB) index.

5. The apparatus of clause 1, wherein the first reference signal and the second reference signal each comprise a synchronization signal, wherein information indicative of a sequence of OAM modes to be used to receive synchronization signals is stored in memory, and wherein the information indicative of the sequence of OAM modes to be used to receive the synchronization signals includes information indicative of a location of the first OAM mode in the sequence and a location of the second OAM mode in the sequence.

6. The apparatus of clause 5, wherein the processor and the memory are further configured to: receive, via the transceiver, the information indicative of the sequence of OAM modes to be used to receive the synchronization signals.

7. The apparatus of clause 5, wherein the information indicative of the sequence of OAM modes to be used to receive the synchronization signals comprises a list of OAM modes.

8. The apparatus of clause 5, wherein the information indicative of the sequence of OAM modes to be used to receive the synchronization signals comprises information indicative of a starting mode in the sequence of OAM modes and information indicative of a number of OAM modes included in the sequence.

9. The apparatus of clause 8, wherein the information indicative of the starting mode in the sequence of OAM modes comprises a value N corresponding to the starting mode, indicating that the sequence begins at a mode l=N or l=−N.

10. The apparatus of clause 8, wherein the information indicative of the number of OAM modes included in the sequence comprises a value 2N+1 corresponding to a length of the sequence.

11. The apparatus of any one of clauses 5-10, wherein the information indicative of the sequence of OAM modes to be used to receive the synchronization signals is received from a transmitter device that transmitted the first reference signal.

12. The apparatus of any one of clauses 5-10, wherein the information indicative of the sequence of OAM modes to be used to receive the synchronization signals is received from a device other than a transmitting device that transmitted the first reference signal.

13. The apparatus of any one of clauses 5-12, wherein the information indicative of the sequence of OAM modes to be used to receive the synchronization signals is included in a system information block.

14. The apparatus of any one of clauses 1-13, further comprising a uniform circular array (UCA) that includes the first antenna element, and a second antenna element of the plurality of antenna elements.

15. An apparatus configured for wireless communication, comprising: a processor; a plurality of antenna elements; a transceiver coupled to the processor and to plurality of antenna elements; and a memory coupled to the processor, wherein the processor and the memory are configured to: transmit, via the transceiver, information indicative of a sequence of orbital angular momentum (OAM) modes to be used to transmit synchronization signals, including a first OAM mode and a second OAM mode; transmit, via the transceiver and a first antenna element of the plurality of antenna elements, a first reference signal on the first OAM mode using first resources in accordance with the sequence; transmit, via the transceiver and the first antenna element of the plurality of antenna elements, a second reference signal on the second OAM mode using second resources in accordance with the sequence.

16. The apparatus of clause 15, wherein the first reference signal is included in a synchronization signal block (SSB).

17. The apparatus of clause 15, wherein the information indicative of the sequence of OAM modes to be used to transmit synchronization signals is stored in memory, and wherein the processor and the memory are further configured to: determine that the second OAM mode is to be used to transmit the second reference signal based on an SSB index associated with the second resources in the information indicative of the sequence of OAM modes to be used to transmit synchronization signals.

18. The apparatus of any one of clauses 15-17, wherein each of a plurality of OAM modes is associated with not more than one synchronization signal block (SSB) index.

19. The apparatus of clause 15, wherein the first reference signal and the second reference signal each comprise synchronization signals, wherein the information indicative of the sequence of OAM modes to be used to transmit synchronization signals is stored in memory, and wherein the information indicative of the sequence of OAM modes to be used to transmit synchronization signals includes information indicative of a location of the first OAM mode in the sequence and a location of the second OAM mode in the sequence.

20. The apparatus of clause 19, wherein the information indicative of the sequence of OAM modes to be used to transmit the synchronization signals comprises a list of OAM modes.

21. The apparatus of clause 19, wherein the information indicative of the sequence of OAM modes to be used to transmit the synchronization signals comprises information indicative of a starting mode in the sequence of OAM modes and information indicative of a number of OAM modes included in the sequence.

22. The apparatus of clause 21, wherein the information indicative of the starting mode in the sequence of OAM modes comprises a value N corresponding to the starting mode, indicating that the sequence begins at a mode l=N or l=−N.

23. The apparatus of clause 21, wherein the information indicative of the number of OAM modes included in the sequence comprises a value 2N+1 corresponding to a length of the sequence.

24. The apparatus of any one of clauses 19-23, wherein the information indicative of the sequence of OAM modes to be used to transmit the synchronization signals is received, via the transceiver, from another device.

25. The apparatus of any one of clauses 19-24, wherein the processor and the memory are further configured to: transmit, via the transceiver, a system information block comprising the information indicative of the sequence of OAM modes to be used to transmit the synchronization signals.

26. The apparatus of any one of clauses 15-25, further comprising a uniform circular array (UCA) that includes the first antenna element, and the second antenna element.

27. A method for wireless communication, comprising: receiving, via a transceiver and a first antenna element of a plurality of antenna elements, a first reference signal on a first orbital angular momentum (OAM) mode using first resources; identifying, based on the first OAM mode used to receive the first reference signal, a second OAM mode to be used to receive a second reference signal associated with second resources; and receiving, via the transceiver and the first antenna element of the plurality of antenna elements, the second reference signal on the second OAM mode using the second resources.

28. The method of clause 27, wherein the first reference signal is included in a synchronization signal block (SSB).

29. The method of clause 28, further comprising: determining an SSB index associated with the first OAM mode based on information stored in memory; and identifying the second OAM mode based on an SSB index associated with the second resources in the information stored in memory.

30. The method of any one of clauses 27 to 29, wherein each of a plurality of OAM modes is associated with not more than one synchronization signal block (SSB) index.

31. The method of clause 27, wherein the first reference signal and the second reference signal each comprise a synchronization signal, wherein information indicative of a sequence of OAM modes to be used to receive synchronization signals is stored in memory, and wherein the information indicative of the sequence of OAM modes to be used to receive the synchronization signals includes information indicative of a location of the first OAM mode in the sequence and a location of the second OAM mode in the sequence.

32. The method of clause 31, further comprising: receiving, via the transceiver, the information indicative of the sequence of OAM modes to be used to receive the synchronization signals.

33. The method of clause 31, wherein the information indicative of the sequence of OAM modes to be used to receive the synchronization signals comprises a list of OAM modes.

34. The method of clause 31, wherein the information indicative of the sequence of OAM modes to be used to receive the synchronization signals comprises information indicative of a starting mode in the sequence of OAM modes and information indicative of a number of OAM modes included in the sequence.

35. The method of clause 34, wherein the information indicative of the starting mode in the sequence of OAM modes comprises a value N corresponding to the starting mode, indicating that the sequence begins at a mode l=N or l=−N.

36. The method of clause 34, wherein the information indicative of the number of OAM modes included in the sequence comprises a value 2N+1 corresponding to a length of the sequence.

37. The method of any one of clauses 31-36, wherein the information indicative of the sequence of OAM modes to be used to receive the synchronization signals is received from a transmitter device that transmitted the first reference signal.

38. The method of any one of clauses 31-36, wherein the information indicative of the sequence of OAM modes to be used to receive the synchronization signals is received from a device other than a transmitting device that transmitted the first reference signal.

39. The method of any one of clauses 31-38, wherein the information indicative of the sequence of OAM modes to be used to receive the synchronization signals is included in a system information block.

40. The method of any one of clauses 27-39, wherein the first antenna element and a second antenna element of the plurality of antenna elements is included in a uniform circular array (UCA).

41. A method for wireless communication, comprising: transmitting, via a transceiver, information indicative of a sequence of orbital angular momentum (OAM) modes to be used to transmit synchronization signals, including a first OAM mode and a second OAM mode; transmitting, via a transceiver and a first antenna element of a plurality of antenna elements, a first reference signal on the first OAM mode using first resources in accordance with the sequence; transmitting, via the transceiver and the first antenna element of the plurality of antenna elements, a second reference signal on the second OAM mode using second resources in accordance with the sequence.

42. The method of clause 41, wherein the first reference signal is included in a synchronization signal block (SSB).

43. The method of clause 41, wherein the information indicative of the sequence of OAM modes to be used to transmit synchronization signals is stored in memory, and wherein the method further comprises: determining that the second OAM mode is to be used to transmit the second reference signal based on an SSB index associated with the second resources in the information indicative of the sequence of OAM modes to be used to transmit synchronization signals.

44. The method of any one of clauses 41-43, wherein each of a plurality of OAM modes is associated with not more than one synchronization signal block (SSB) index.

45. The method of clause 41, wherein the first reference signal and the second reference signal each comprise synchronization signals, wherein the information indicative of the sequence of OAM modes to be used to transmit synchronization signals is stored in memory, and wherein the information indicative of the sequence of OAM modes to be used to transmit synchronization signals includes information indicative of a location of the first OAM mode in the sequence and a location of the second OAM mode in the sequence.

46. The method of clause 45, wherein the information indicative of the sequence of OAM modes to be used to transmit the synchronization signals comprises a list of OAM modes.

47. The method of clause 45, wherein the information indicative of the sequence of OAM modes to be used to transmit the synchronization signals comprises information indicative of a starting mode in the sequence of OAM modes and information indicative of a number of OAM modes included in the sequence.

48. The method of clause 47, wherein the information indicative of the starting mode in the sequence of OAM modes comprises a value N corresponding to the starting mode, indicating that the sequence begins at a mode l=N or l=−N.

49. The method of clause 47, wherein the information indicative of the number of OAM modes included in the sequence comprises a value 2N+1 corresponding to a length of the sequence.

50. The method of any one of clauses 45-49, wherein the information indicative of the sequence of OAM modes to be used to transmit the synchronization signals is received, via the transceiver, from another device.

51. The method of any one of clauses 45-50, further comprising: transmitting, via the transceiver, a system information block comprising the information indicative of the sequence of OAM modes to be used to transmit the synchronization signals.

52. The method of any one of clauses 41-51, wherein the first antenna element and a second antenna element of the plurality of antenna elements is included in a uniform circular array (UCA).

53. An apparatus for wireless communication, comprising: a processor; and a memory communicatively coupled to the at least one processor, wherein the processor and memory are configured to: perform a method of any of clauses 27 to 52.

54. A non-transitory computer-readable medium storing computer-executable code, comprising code for causing a computer to cause a processor to: perform a method of any of clauses 27 to 52.

55. An apparatus for wireless communication, comprising: at least one means for carrying out a method of any of clauses 27 to 52.

One or more of the components, steps, features and/or functions illustrated in FIGS. 1-8 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-8 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus configured for wireless communication, comprising:
a processor;
a plurality of antenna elements;
a transceiver coupled to the processor and to plurality of antenna elements; and
a memory coupled to the processor,
wherein the processor and the memory are configured to:
receive, via the transceiver and a first antenna element of the plurality of antenna elements, a first reference signal on a first orbital angular momentum (OAM) mode using first resources;
identify, based on the first OAM mode used to receive the first reference signal, a second OAM mode to be used to receive a second reference signal associated with second resources; and
receive, via the transceiver and the first antenna element of the plurality of antenna elements, the second reference signal on the second OAM mode using the second resources.

2. The apparatus of claim 1, wherein the first reference signal is included in a synchronization signal block (SSB).

3. The apparatus of claim 2, wherein the processor and the memory are further configured to:
determine an SSB index associated with the first OAM mode based on information stored in memory; and
identify the second OAM mode based on an SSB index associated with the second resources in the information stored in memory.

4. The apparatus of claim 1, wherein each of a plurality of OAM modes is associated with not more than one synchronization signal block (SSB) index.

5. The apparatus of claim 1, wherein the first reference signal and the second reference signal each comprise a synchronization signal, wherein information indicative of a sequence of OAM modes to be used to receive synchronization signals is stored in memory, and wherein the information indicative of the sequence of OAM modes to be used to receive the synchronization signals includes information indicative of a location of the first OAM mode in the sequence and a location of the second OAM mode in the sequence.

6. The apparatus of claim 5, wherein the processor and the memory are further configured to:
receive, via the transceiver, the information indicative of the sequence of OAM modes to be used to receive the synchronization signals.

7. The apparatus of claim 5, wherein the information indicative of the sequence of OAM modes to be used to receive the synchronization signals is included in a system information block.

8. The apparatus of claim 1, further comprising a uniform circular array (UCA) that includes the first antenna element, and a second antenna element of the plurality of antenna elements.

9. An apparatus configured for wireless communication, comprising:
a processor;
a plurality of antenna elements;
a transceiver coupled to the processor and to plurality of antenna elements; and
a memory coupled to the processor,
wherein the processor and the memory are configured to:
transmit, via the transceiver, information indicative of a sequence of orbital angular momentum (OAM) modes to be used to transmit synchronization signals, including a first OAM mode and a second OAM mode;
transmit, via the transceiver and a first antenna element of the plurality of antenna elements, a first reference signal on the first OAM mode using first resources in accordance with the sequence;
transmit, via the transceiver and the first antenna element of the plurality of antenna elements, a second reference signal on the second OAM mode using second resources in accordance with the sequence.

10. The apparatus of claim 9, wherein the first reference signal is included in a synchronization signal block (SSB).

11. The apparatus of claim 9, wherein the information indicative of the sequence of OAM modes to be used to transmit synchronization signals is stored in memory, and wherein the processor and the memory are further configured to:
determine that the second OAM mode is to be used to transmit the second reference signal based on an SSB index associated with the second resources in the information indicative of the sequence of OAM modes to be used to transmit synchronization signals.

12. The apparatus of claim 9, wherein each of a plurality of OAM modes is associated with not more than one synchronization signal block (SSB) index.

13. The apparatus of claim 9, wherein the first reference signal and the second reference signal each comprise synchronization signals, wherein the information indicative of the sequence of OAM modes to be used to transmit synchronization signals is stored in memory, and wherein the information indicative of the sequence of OAM modes to be used to transmit synchronization signals includes information indicative of a location of the first OAM mode in the sequence and a location of the second OAM mode in the sequence.

14. The apparatus of claim 13, wherein the processor and the memory are further configured to:
transmit, via the transceiver, a system information block comprising the information indicative of the sequence of OAM modes to be used to transmit the synchronization signals.

15. The apparatus of claim 9, further comprising a uniform circular array (UCA) that includes the first antenna element, and a second antenna element of the plurality of antenna elements.

16. A method for wireless communication, comprising:
receiving, via a transceiver and a first antenna element of a plurality of antenna elements, a first reference signal on a first orbital angular momentum (OAM) mode using first resources;
identifying, based on the first OAM mode used to receive the first reference signal, a second OAM mode to be used to receive a second reference signal associated with second resources; and
receiving, via the transceiver and the first antenna element of the plurality of antenna elements, the second reference signal on the second OAM mode using the second resources.

17. The method of claim 16, wherein the first reference signal is included in a synchronization signal block (SSB).

18. The method of claim 17, further comprising:
determining an SSB index associated with the first OAM mode based on information stored in memory; and
identifying the second OAM mode based on an SSB index associated with the second resources in the information stored in memory.

19. The method of claim 16, wherein each of a plurality of OAM modes is associated with not more than one synchronization signal block (SSB) index.

20. The method of claim 16, wherein the first reference signal and the second reference signal each comprise a synchronization signal, wherein information indicative of a sequence of OAM modes to be used to receive synchronization signals is stored in memory, and wherein the information indicative of the sequence of OAM modes to be used to receive the synchronization signals includes information indicative of a location of the first OAM mode in the sequence and a location of the second OAM mode in the sequence.

21. The method of claim 20, further comprising:
receiving, via the transceiver, the information indicative of the sequence of OAM modes to be used to receive the synchronization signals.

22. The method of claim 19, wherein the information indicative of the sequence of OAM modes to be used to receive the synchronization signals is included in a system information block.

23. The method of claim 16, wherein the first antenna element and a second antenna element of the plurality of antenna elements is included in a uniform circular array (UCA).

24. A method for wireless communication, comprising:
transmitting, via a transceiver, information indicative of a sequence of orbital angular momentum (OAM) modes to be used to transmit synchronization signals, including a first OAM mode and a second OAM mode;
transmitting, via a transceiver and a first antenna element of a plurality of antenna elements, a first reference signal on the first OAM mode using first resources in accordance with the sequence;
transmitting, via the transceiver and the first antenna element of the plurality of antenna elements, a second reference signal on the second OAM mode using second resources in accordance with the sequence.

25. The method of claim 24, wherein the first reference signal is included in a synchronization signal block (SSB).

26. The method of claim 24, wherein the information indicative of the sequence of OAM modes to be used to transmit synchronization signals is stored in memory, and wherein the method further comprises:
determining that the second OAM mode is to be used to transmit the second reference signal based on an SSB index associated with the second resources in the information indicative of the sequence of OAM modes to be used to transmit synchronization signals.

27. The method of claim 24, wherein each of a plurality of OAM modes is associated with not more than one synchronization signal block (SSB) index.

28. The method of claim 24, wherein the first reference signal and the second reference signal each comprise synchronization signals, wherein the information indicative of the sequence of OAM modes to be used to transmit synchronization signals is stored in memory, and wherein the information indicative of the sequence of OAM modes to be used to transmit synchronization signals includes information indicative of a location of the first OAM mode in the sequence and a location of the second OAM mode in the sequence.

29. The method of claim 24, further comprising:
transmitting, via the transceiver, a system information block comprising the information indicative of the sequence of OAM modes to be used to transmit the synchronization signals.

30. The method of claim 24, wherein the first antenna element and a second antenna element of the plurality of antenna elements is included in a uniform circular array (UCA).
